(19) United States
(12) Patent Application Publication
(10) Pub. No.: US 2018/0181281 A1
(43) Pub. Date: Jun. 28, 2018

(54) INFORMATION PROCESSING APPARATUS, INFORMATION PROCESSING METHOD, AND PROGRAM

(71) Applicant: SONY CORPORATION, TOKYO (JP)

(72) Inventor: Yasuyuki SUKI, TOKYO (JP)

(21) Appl. No.: 15/738,707

(22) PCT Filed: May 31, 2016
(86) PCT No.: PCT/JP2016/065999

§ 371 Date: Dec. 21, 2017

(30) Foreign Application Priority Data
Jun. 30, 2015 (JP) 2015-131362

(51) Int. Cl. G06F 3/0484; G06F 3/0485; G06T 11/60; G09B 29/10; G09B 29/00

(52) U.S. Cl. CPC G06F 3/04842; G06F 3/0485; G06T 2200/24; G09B 29/10; G09B 29/003; G06T 11/60

(57) ABSTRACT

[Object] To make it possible to further improve user-friendliness.

[Solution] Provided is an information processing apparatus including: a display pattern determining unit configured to determine a display pattern of a plurality of images. The display pattern determining unit determines, on the basis of scattering of a plurality of pieces of position information including position information associated with each of the plurality of images, a display pattern in which the plurality of images are arranged along with a map including a location corresponding to the position information.

### TECHNICAL FIELD

The present disclosure relates to an information processing apparatus, an information processing method, and a program.

### BACKGROUND ART

Typically, addition of position information of a location where a photograph is taken to photograph data as meta information is widely performed. For example, Patent Literature 1 discloses a technology of providing a user interface (UI) for allowing a user to easily correct association in the case where photograph data is not appropriately associated with position information due to an error of an internal clock of a camera, a time difference, or the like.

### CITATION LIST

### Patent Literature

Patent Literature 1: JP 2009-171269A

### DISCLOSURE OF INVENTION

### Technical Problem

Meanwhile, there exists a system which automatically organizes and edits a plurality of pieces of image data (for example, photograph data) possessed by a user. In such a system, by using position information associated with the image data to organize and edit the plurality of pieces of image data, there is a possibility that a system with higher user-friendliness for the user can be provided.

Therefore, the present disclosure proposes a new and improved information processing apparatus, information processing method and program which can further improve user-friendliness.

### Solution to Problem

According to the present disclosure, there is provided an information processing apparatus including: a display pattern determining unit configured to determine a display pattern of a plurality of images. The display pattern determining unit determines, on the basis of scattering of a plurality of pieces of position information including position information associated with each of the plurality of images, a display pattern in which the plurality of images are arranged along with a map including a location corresponding to the position information.

In addition, according to the present disclosure, there is provided an information processing method including: determining a display pattern of a plurality of images by a processor. On the basis of scattering of a plurality of pieces of position information including position information associated with each of the plurality of images, a display pattern in which the plurality of images are arranged along with a map including a location corresponding to the position information is determined.

In addition, according to the present disclosure, there is provided a program causing a computer to implement: a function of determining a display pattern of a plurality of images. On the basis of scattering of a plurality of pieces of position information including position information associated with each of the plurality of images, a display pattern in which the plurality of images are arranged along with a map including a location corresponding to the position information is determined.

According to the present disclosure, when a display pattern for displaying a plurality of images is determined, the display pattern in which the plurality of images are arranged along with a map including a location corresponding to position information is determined on the basis of scattering of pieces of position information respectively associated with the plurality of images (for example, photographs taken with a camera). The map can indicate history of movement of the user when the images are created (when the photographs are taken). Therefore, by the images and the map being displayed together, the user (a person who browses the images) can recognize a situation where these images are created, for example, locations the user has stopped by during travel, or the like, at the same time as well as content of these images. In this manner, according to the present disclosure, it is possible to organize and edit images with higher user-friendliness.

### Advantageous Effects of Invention

As described above, according to the present disclosure, it is possible to further improve user-friendliness. Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a functional block diagram illustrating an example of a functional configuration of an information processing apparatus according to the present embodiment.

FIG. 2 is a diagram illustrating a configuration of a display screen according to the present embodiment.

FIG. 3 is a diagram illustrating an arrangement example of images in a display pattern A.

FIG. 4 is a diagram illustrating an arrangement example of images in a display pattern B.

FIG. 5 is a diagram illustrating an arrangement example of images in a display pattern C.

FIG. 6 is a diagram illustrating an arrangement example of images in a display pattern D.

FIG. 7A is a diagram illustrating a display example when the display pattern B is scrolled.

FIG. 7B is a diagram illustrating a display example when the display pattern B is scrolled.

FIG. 7C is a diagram illustrating a display example when the display pattern B is scrolled.

FIG. 7D is a diagram illustrating a display example when the display pattern B is scrolled.

FIG. 7E is a diagram illustrating a display example when the display pattern B is scrolled.

FIG. 7F is a diagram illustrating a display example when the display pattern B is scrolled.

FIG. 7G is a diagram illustrating a display example when the display pattern B is scrolled.

FIG. 7H is a diagram illustrating a display example when the display pattern B is scrolled.

FIG. 7I is a diagram illustrating a display example when the display pattern B is scrolled.

FIG. 8 is a diagram illustrating an example of transition of display when an image is selected by a user.

FIG. 9 is a flowchart illustrating an example of processing procedure of an information processing method according to the present embodiment.

FIG. 10 is a diagram illustrating outline of photo delivery service to which the information processing apparatus according to the present embodiment can be applied.

FIG. 11 is a block diagram illustrating a functional configuration of a system in the case where the information processing apparatus according to the present embodiment is applied to the photo delivery service.

FIG. 12 is a diagram illustrating a display screen relating to a UI provided to a sender upon setup of the photo delivery service in the case where an information processing terminal is a PC.

FIG. 13 is a diagram illustrating a display screen relating to a UI provided to a sender upon setup of the photo delivery service in the case where an information processing terminal is a PC.

FIG. 14 is a diagram illustrating a display screen relating to a UI provided to a sender upon setup of the photo delivery service in the case where an information processing terminal is a PC.

FIG. 15 is a diagram illustrating a display screen relating to a UI provided to a sender upon setup of the photo delivery service in the case where an information processing terminal is a PC.

FIG. 16 is a diagram illustrating a display screen relating to a UI provided to a sender upon setup of the photo delivery service in the case where an information processing terminal is a PC.

FIG. 17 is a diagram illustrating a display screen relating to the UI provided upon setup of the photo delivery service in the case where the information processing terminal is a device having a touch panel.

FIG. 18 is a diagram illustrating a display screen relating to the UI provided when a photo album before being delivered is confirmed.

FIG. 19 is a diagram illustrating a display screen relating to the UI provided to a receiver when the photo album is browsed in the case where the information processing terminal is a PC.

FIG. 20 is a diagram illustrating a display screen relating to the UI provided to a receiver when the photo album is browsed in the case where the information processing terminal is a PC.

FIG. 21 is a diagram illustrating a display screen relating to the UI provided to the receiver when the photo album is browsed in the case where the information processing terminal is a device having a touch panel.

FIG. 22 is a diagram illustrating a display screen relating to the UI provided to the receiver when the photo album is browsed in the case where the information processing terminal is a device having a touch panel.

FIG. 23 is a diagram illustrating a display screen relating to the UI provided to the receiver when the photo album is browsed in the case where the information processing terminal is a device having a touch panel.

FIG. 24 is a diagram illustrating a display screen relating to the UI provided to the sender when information as to a favorite photograph is fed back.

FIG. 25 is a diagram illustrating another display example in the display pattern B.

FIG. 26 is a diagram illustrating another display example in the display pattern B.

FIG. 27 is a diagram illustrating another display example in the display pattern B.

FIG. 28 is a diagram illustrating another display example in the display pattern B.

FIG. 29 is a diagram illustrating another display example in the display pattern B.

FIG. 30 is a diagram illustrating another display example in the display pattern B.

FIG. 31 is a block diagram illustrating an example of a hardware configuration of the information processing apparatus according to the present embodiment.

### MODE FOR CARRYING OUT THE INVENTION

Hereinafter, a preferred embodiment of the present disclosure will be described in detail with reference to the appended drawings. In this specification and the appended drawings, structural elements that have substantially the same function and structure are denoted with the same reference numerals, and repeated explanation of these structural elements is omitted.

Note that description will be provided in the following order.

1. Configuration of information processing apparatus
2. Examples of display pattern
2-1. Perspective of each display pattern
2-2. Display example upon scrolling in display pattern B
2-3. Display example upon image selection
3. Information processing method
4. Application example
4-1. System configuration

### 4-2. Examples of UI

4-2-1. Upon generation of photo album (sender side)
4-2-2. Upon browsing of photo album (receiver side)
4-2-3. Upon feedback (sender side)
5. Modified examples
5-1. Other display examples in display pattern B
5-2. Criterion for image extraction processing and display pattern determination processing
5-3. Scrolling operation
5-4. Display apparatus
6. Hardware configuration

### 7. Supplement

### 1. Configuration of Information Processing Apparatus

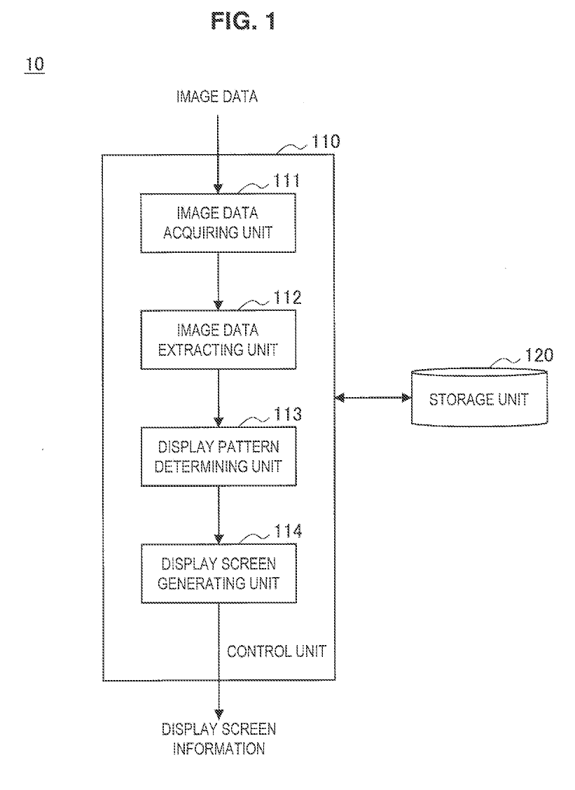

A configuration of an information processing apparatus according to an embodiment of the present disclosure will be described with reference to FIG. 1. FIG. 1 is a functional block diagram illustrating an example of a functional configuration of the information processing apparatus according to the present embodiment.

Referring to FIG. 1, the information processing apparatus 10 according to the present embodiment includes a control unit 110 and a storage unit 120 as its functions. Further, the control unit 110 includes an image data acquiring unit 111, an image data extracting unit 112, a display pattern determining unit 113 and a display screen generating unit 114 as its functions. The information processing apparatus 10 executes processing of extracting some pieces of image data among a plurality of pieces of image data on the basis of predetermined conditions, determining a display pattern which is an arrangement pattern of images according to the extracted image data and generating a display screen in which the images are arranged according to the determined display pattern.

Note that a case will be described below as an example where the image data to be processed by the information processing apparatus 10 is photograph data. Therefore, in the following description, “creating images (data)” will be also expressed as “photographing images (photographs)”, or the like. However, the present embodiment is not limited to this example, and the information processing apparatus 10 processes an arbitrary type of image data.

Further, what is actually processed by the information processing apparatus 10 is “image data” (that is, electronic data of an image), and an “image” actually displayed to a user is an image relating to image data. However, in the following description, to avoid redundant description, an image will be simply described as an “image” for convenience sake even in the case where an image essentially means an “image relating to image data”.

The control unit 110 is control means which is configured with various kinds of processors such as, for example, a central processing unit (CPU), a digital signal processor (DSP) and an application specific integrated circuit (ASIC), and which controls operation of the information processing apparatus 10 by executing predetermined arithmetic processing. The above-described respective functions are implemented by processors constituting the control unit 110 operating according to a predetermined program.

The image data acquiring unit 111 acquires a plurality of pieces of electronic data of images (image data) possessed by the user. The image data is, for example, photograph data photographed by the user.

For example, the image data acquiring unit 111 acquires image data stored by the user in a predetermined storage region (for example, a folder designated in advance) within the information processing apparatus 10. However, the present embodiment is not limited to this example, and the image data acquiring unit 111 may automatically acquire any image data stored within the information processing apparatus 10 by searching the storage region of the information processing apparatus 10.

Further, the image data acquiring unit 111 acquires metadata associated with the image data along with the image data when acquiring the image data. The metadata can include, for example, position information indicating a location where an image is photographed (that is, a location where a photograph is taken), time information indicating date and time when an image is photographed (that is, date and time when a photograph is taken), model information indicating a model of a camera with which the user takes a photograph, or the like. Further, in the case where relation between the model information and an owner of the camera is known in advance, the metadata may include photographer information indicating a person who photographs an image (that is, a person who takes a photograph) on the basis of the model information. In addition, the metadata may include various kinds of information typically included in metadata of photograph data.

The image data acquiring unit 111 provides the acquired image data to the image data extracting unit 112. Alternatively, the image data acquiring unit 111 may store the acquired image data in the storage unit 120, and the image data extracting unit 112 may execute processing which will be described later by accessing the storage unit 120 to acquire the image data.

The image data extracting unit 112 extracts image data which is to be finally included in a display screen on the basis of predetermined conditions (that is, which is to be finally presented to the user) among a plurality of pieces of image data acquired by the image data acquiring unit 111. As will be described later, in the present embodiment, a display screen in which image data is organized for each predetermined period such as, for example, one month, is generated. In one display screen, images acquired within the corresponding period are arranged in a predetermined display pattern. Therefore, for example, in the case where an enormous number of pieces of image data are acquired in the predetermined period, if all pieces of the image data are arranged in the display screen, there is a concern that the display screen becomes complicated, which may degrade visibility of the user who browses the display screen.

Therefore, a predetermined number of pieces of image data are extracted by the image data extracting unit 112, and only images relating to the extracted image data are displayed. Note that the number of pieces of image data extracted by the image data extracting unit 112 may be set as appropriate by a designer, a user, or the like, of the information processing apparatus 10. For example, it is considered that an appropriate number of pieces of the image data is from 30 to 50 in terms of usability in the case where the image data is arranged in one display screen.

For example, the image data extracting unit 112 classifies a plurality of pieces of image data acquired in the predetermined period by events and extracts a predetermined number of pieces of image data in accordance with predetermined priority for each event. Here, as a technology of classifying the image data by events (event clustering), for example, a technology in which photograph data is classified in accordance with locations where photographs are taken and time when photographs are taken is known. Because various kinds of publicly known methods may be used as event clustering, detailed description will be omitted here. For example, as event clustering, methods disclosed in JP 2008-250605A and JP 2011-113270A which are prior applications by the applicant of the present application can be used.

Further, the number of pieces of image data to be extracted for each event may be determined as appropriate while the total number of pieces of image data to be extracted by the image data extracting unit 112 is taken into account. For example, in the case where the total number of pieces of image data to be extracted by the image data extracting unit 112 is set at 30 and the image data acquired in a predetermined period is classified into three events as a result of event clustering, the image data extracting unit 112 may equally extract 10 pieces of image data for each event.

However, the image data extracting unit 112 may set a degree of importance for each event, and, in the case where there exists a difference in the degree of importance between events, the image data extracting unit 112 may extract image data for each event at a ratio in accordance with the degree of importance. For example, in the case where it is inferred on the basis of position information of the image data that these images are photographed at a location away from a usual living range of the user, because it is considered that these images are photographed during an event which is different from a usual life, such as during travel, a higher degree of importance can be set. Alternatively, a degree of importance may be judged as higher for an event to which more pieces of image data belong on the basis of the number of pieces of image data for each event.

Further, as priority which becomes a criterion used by the image data extracting unit 112 to extract image data, priority in accordance with a person included in the image can be preferably used. For example, the image data extracting unit 112 can set priority to each image data so that higher priority is set for an image including a person X designated in advance by the user and can extract image data for each event in accordance with the priority. The priority can be set, for example, as indicated in the following table 1.

TABLE 1

| Content of image (photograph) | Priority |
|---|---|
| Closeup of face of person X | high |
| Full-length figure of person X | medium |
| (indicating action of person X) | |
| Including person X and another person Y | medium |
| (such as photograph of family and friends) | |
| Not including person X | low |
| (indicating surroundings and environment) | |

Note that whether the person X is included in the image (whether the person X appears in the photograph) may be judged using various kinds of publicly known technologies such as face recognition and person recognition. Further, whether the image indicates the face of the person X or full-length figure may be judged using various kinds of publicly known composition recognition technologies.

Here, even in the case where there are a plurality of pieces of image data having the same level of priority, in the case where compositions of these images are similar, the image data extracting unit 112 may extract only one of them while regarding these pieces of image data are the same piece of image data when extracting the image data. Further, in this event, the image data extracting unit 112 may preferentially select an image including specific expression such as, for example, an image in which the person X smiles a lot more using a face recognition technology, or the like.

The image data extracting unit 112 provides the extracted image data to the display pattern determining unit 113. Alternatively, the image data extracting unit 112 may store the extracted image data in the storage unit 120, and the display pattern determining unit 113 may execute processing which will be described later by accessing the storage unit 120 to acquire the image data.

Note that, while, in the above-described example, the image data extracting unit 112 classifies a plurality of pieces of image data by events, the present embodiment is not limited to this example. The image data extracting unit 112 only has to classify the image data by categories in accordance with a predetermined criterion and extract a predetermined number of pieces of image data for each category, and the categories are not limited to events. For example, the image data extracting unit 112 may classify the image data for each predetermined period such as, for example, per week, in accordance with date and time when images are photographed on the basis of time information of the image data.

Further, while, in the above-described example, the image data extracting unit 112 uses priority based on a person included in the image as priority which becomes a criterion for extracting image data, the present embodiment is not limited to this example. For example, the image data extracting unit 112 may extract image data using priority based on time when images are photographed by the user (time when photographs are taken) or locations where images are photographed (locations where photographs are taken). Specifically, the image data extracting unit 112 may set higher priority for images photographed within a predetermined period designated as appropriate by the user or images photographed at a predetermined location on the basis of the time information and/or the location information of the image data and may extract the image data in accordance with the priority.

The display pattern determining unit 113 determines a display pattern when images relating to the image data extracted by the image data extracting unit 112 are displayed on a display screen. The display pattern indicates a pattern in which the images are arranged on the display screen. On the display pattern, for example, a thumbnail of images can be displayed in a predetermined pattern. In the present embodiment, forms of a plurality of display patterns are prepared, and the display pattern determining unit 113 determines one display pattern for each event among these forms of the plurality of display patterns. The same display pattern may be determined for each event, or different display patterns may be determined for each event. Note that specific examples of the display patterns and details of processing of determining the display pattern will be described below (2. Examples of display pattern).

The display pattern determining unit 113 provides information as to the determined display pattern of each event to the display screen generating unit 114. Alternatively, the display pattern determining unit 113 may store information as to the determined display pattern of each event in the storage unit 120, and the display screen generating unit 114 may execute processing which will be described later by accessing the storage unit 120 to acquire the information as to the display pattern.

The display screen generating unit 114 generates a display screen to be finally presented to the user using the display pattern of each event determined by the display pattern determining unit 113. Information as to the display screen generated by the display screen generating unit 114 is transmitted to a display apparatus held by the information processing apparatus 10 itself, an information processing terminal possessed by the user, or the like, and presented to the user. Note that the display screen generating unit 114 may store the information as to the generated display screen in the storage unit 120, and the above-described display apparatus, the above-described information processing terminal, or the like, may execute processing of displaying the display screen in the own apparatus by accessing the storage unit 120 to acquire the information as to the display screen.

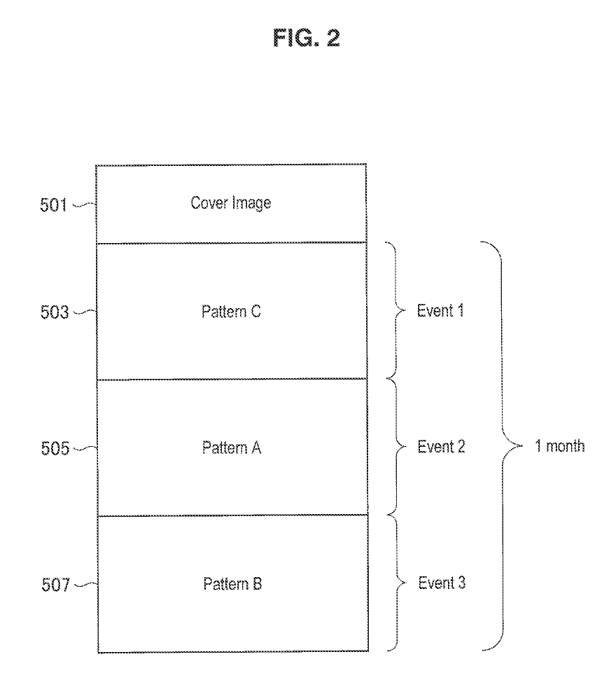

Here, a configuration of the display screen generated by the display screen generating unit 114 will be described with reference to FIG. 2. FIG. 2 is a diagram illustrating a configuration of a display screen according to the present embodiment.

In the present embodiment, one display screen is generated so as to correspond to a predetermined target period during which the image data is extracted by the image date extracting unit 112. FIG. 2 illustrates a configuration example of a display screen in the case where the predetermined period is one month as an example.

As illustrated in FIG. 2, the display screen is configured so that a cover image region 501 in which a cover image is displayed, a first region 503 in which images are arranged in a first display pattern (pattern C in the illustrated example), a second region 505 in which images are arranged in a second display pattern (pattern A in the illustrated example), and a third region 507 in which images are arranged in a third display pattern (pattern B in the illustrated example) continue in this order.

Here, the first display pattern, the second display pattern and the third display pattern respectively correspond to a first event, a second event and a third event occurring during a target period (that is, one month). Further, these display patterns are arranged from the top to the bottom in order of occurrence of events, that is, in chronological order. That is, it can be said that, in the display screen, as a whole, images acquired for one month are arranged for each event in chronological order. In the cover image region 501, a title of the display screen, for example, a period corresponding to the display screen (such as “2014 August”) is displayed.

In the case where the user actually browses the display screen, it is not necessary to present the whole display screen illustrated in FIG. 2 at one time, and, for example, only partial region in a vertical direction of the display screen may be displayed in a display region of an information processing terminal possessed by the user, so that the user can browse the display screen while scrolling display in the vertical direction. The user can visually recognize events occurring in the period in chronological order through images by sequentially browsing the display screen from the top.

Note that, while, in the illustrated example, three events occur in one month and the display screen is configured with three display regions 503, 505 and 507 using three types of display patterns in accordance with the three events, the present embodiment is not limited to this example. In the case where the number of events occurring within the predetermined period is different, the number of types of display patterns which constitute the display screen can, of course, change in accordance with the number of events. Further, the display screen does not always have to be configured with a plurality of types of display patterns, and the display screen may be configured with one type of display pattern.

Further, the user may be allowed to edit as appropriate a display screen automatically generated by the display screen generating unit 114. For example, the user can replace images included in the display screen or can change sizes of the images.

The storage unit 120 is storage means which is configured with various kinds of storage devices such as, for example, a magnetic storage device such as a hard disk drive (HDD), a semiconductor storage device, an optical storage device and a magnetooptical disk and which stores various kinds of information. In the storage unit 120, various kinds of information to be processed by the control unit 110, a result of processing by the control unit 110, or the like, can be stored.

For example, the storage unit 120 stores image data acquired by the image data acquiring unit 111, image data extracted by the image data extracting unit 112, information as to the display pattern determined by the display pattern determining unit 113 and/or information as to the display screen generated by the display screen generating unit 114. Further, for example, the storage unit 120 stores information as to a criterion for classifying image data, a criterion for extracting image data, or the like, to be used when the image data extracting unit 112 extracts image data. Further, for example, the storage unit 120 stores information as to forms of display patterns and a criterion for determining a display pattern to be used when the display pattern determining unit 113 determines a display pattern.

The functional configuration of the information processing apparatus according to the present embodiment has been described above with reference to FIG. 1. Note that the information processing apparatus 10 only has to be configured so as to be able to realize the above-described functions and a specific hardware configuration is not limited. For example, the information processing apparatus 10 can be a desk top personal computer (PC), a tablet PC, a smartphone, a wearable device (such as, for example, a spectacle type terminal and a head mounted display (HMD)), or the like. Alternatively, the information processing apparatus 10 may be a server dedicated to arithmetic processing provided on a network (on so-called cloud).

Further, each function illustrated in FIG. 1 does not have to be always executed at one apparatus, and may be executed through cooperation with a plurality of apparatuses. For example, functions equivalent to those of the information processing apparatus 10 illustrated in FIG. 1 may be implemented by one apparatus having part of respective functions of the information processing apparatus 10 illustrated in FIG. 1 being connected to other apparatuses having other functions so as to be able to perform communication.

Further, it is possible to create a computer program for implementing each function of the information processing apparatus 10 illustrated in FIG. 1, particularly, each function of the control unit 110, and implement the computer program at a processing apparatus of a PC, or the like. Further, it is possible to provide a computer readable recording medium in which such a computer program is stored. The recording medium is, for example, a magnetic disk, an optical disk, a magnetooptical disk, a flash memory, or the like. Further, the above-described computer program may be delivered via, for example, a network without using a recording medium.

### 2. Examples of Display Pattern

### (2-1. Perspective of Each Display Pattern)

Some examples of the display pattern in the present embodiment will be described. In the present embodiment, the above-described display pattern determining unit 113 can determine one display pattern among the following display pattern A to a display pattern D in accordance with predetermined conditions. Note that, while four display patterns (the display pattern A to the display pattern D) will be described as an example here, the present embodiment is not limited to this example, and other various kinds of display patterns may be used.

(Display pattern A)

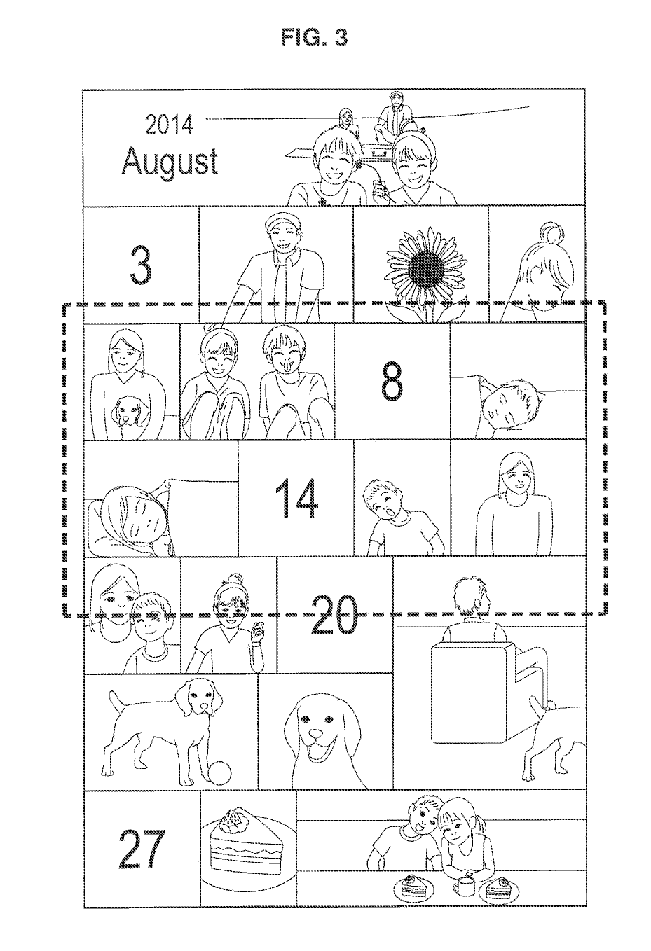

The display pattern A will be described with reference to FIG. 3. FIG. 3 is a diagram illustrating an arrangement example of images in the display pattern A. Note that, in FIG. 3 and FIG. 4 to FIG. 6 which will be described later, and which illustrate respective display patterns, a specific example of a cover image illustrated in FIG. 2 is illustrated together.

Referring to FIG. 3, a cover image provided on the top and a group of images arranged below the cover image in accordance with the display pattern A are illustrated. The cover image is formed with, for example, a typical image which represents a period during which the image data is extracted and a title indicating the period. In the illustrated example, because the period during which the image data is extracted is one month, characters of “2014 August” are displayed along with images indicating events occurring at that month.

In the display pattern A, a plurality of images are organized for each photographing date and arranged so as to be paved in the shape of a tile. The respective arranged images may be images themselves relating to the image data or may be images obtained by editing the images (for example, images obtained by trimming the images in a range including at least a predetermined person). Alternatively, the images may be a thumbnail of images relating to the image data or images obtained by editing the thumbnail. Further, the group of images is arranged in chronological order from the top to the bottom.

Note that, also in other display patterns (the display pattern B to the display pattern D), in a similar manner, images to be displayed may be one of images themselves relating to image data, images obtained by editing the images, a thumbnail of the images and images obtained by editing the thumbnail. Further, a size of display of each image in the display pattern A to the display pattern D may be determined as appropriate in accordance with the above-described priority when the image data is extracted so that, for example, an image with higher priority is displayed more largely.

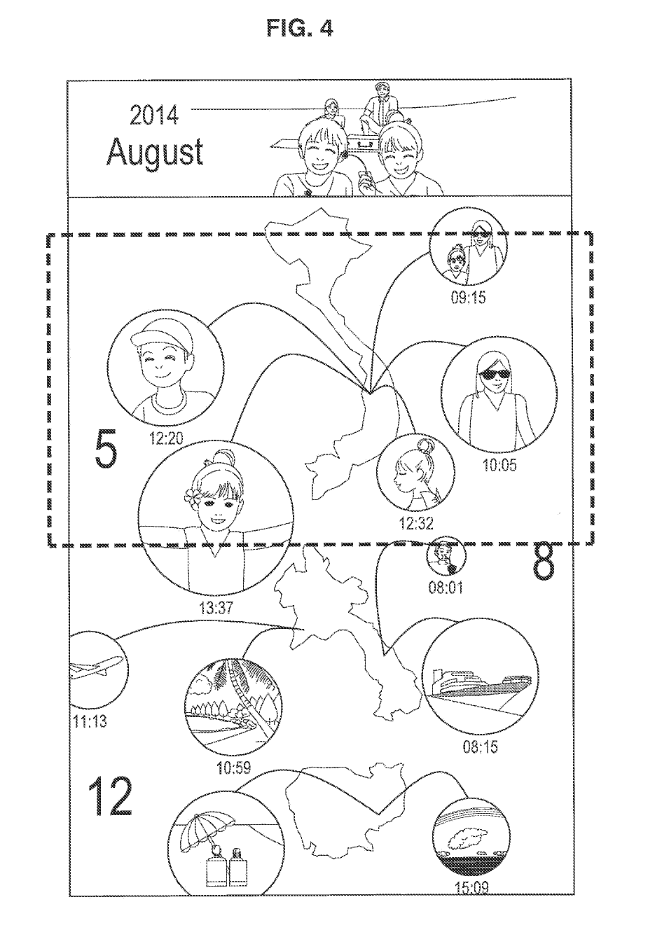

Here, while FIG. 3 illustrates the whole display which can be displayed to the user for convenience sake to explain the display pattern A, a region actually presented to the user at one time (that is, a region displayed at one time at a display apparatus observed by the user) may be part of the display. FIG. 3 illustrates a region presented to the user at one time with a dashed enclosure as an example. Note that, for convenience sake, FIG. 4 to FIG. 6 also illustrate the whole display which can be displayed to the user for the group of images arranged in other display patterns (the display pattern B to the display pattern D) in a similar manner and illustrate regions actually presented to the user at one time with dashed enclosures. The user can observe the group of images in chronological order while scrolling the display in the vertical direction when observing the group of images displayed in each display pattern.

The display pattern A can be preferably employed in the case where, for example, the number of extracted images is larger than a predetermined threshold. In the display pattern A, because a relatively large number of images are presented to the user, the user can see more images and can know content of the event in more details.

(Display pattern B)

The display pattern B will be described with reference to FIG. 4. FIG. 4 is a diagram illustrating an arrangement example of images in the display pattern B. Note that, because the cover image is similar to that illustrated in FIG. 3, detailed description will be omitted.

Referring to FIG. 4, in the display pattern B, a plurality of images are arranged along with a map of a surrounding area including locations where images are photographed. Further, these images can be displayed in association with locations where the images are photographed on the map. In the illustrated example, relation between photographing locations on the map and images photographed at the photographing locations is expressed by the both being connected with lines.

In the vicinity of the group of images, date at which the group of images is photographed is displayed. Further, in the vicinity of each image, time at which the image is photographed is displayed together. Further, the group of images is arranged in chronological order from the top to the bottom.

The display pattern B can be preferably employed in the case where, for example, images are photographed at locations the user does not usually visit (for example, in the case where photographs are taken while traveling). Because, in the display pattern B, history of movement and photographs taken during the movement are displayed in association with each other, it can be considered that the display pattern B is suitable for an event in which emphasis is placed on “movement”. For example, by using the display pattern B, it is possible to recognize change of scenery during movement in association with the photographing locations of the scenery.

For example, the display pattern determining unit 113 can determine whether or not to employ the display pattern B on the basis of scattering of position information of the image data (for example, evaluation of a set value such as dispersion, distribution, standard deviation, a difference between an average value and the farthest value, and a difference value between an easternmost (northernmost) value and a westernmost (southernmost) value). For example, in the case where scattering of the position information varies (dispersion is large), because it can be considered that the user photographs images while moving a long distance, the display pattern B can be preferably employed.

Specifically, for example, information as to action history of the user may be input to the information processing apparatus 10 along with image data, in which case the display pattern determining unit 113 can employ the display pattern B in the case where a location where the image is photographed is away from an activity range of daily life of the user inferred on the basis of the action history, by equal to or greater than a predetermined threshold (equal to or longer than a predetermined distance). Here, the information as to the action history may be acquired on the basis of position information and time information of the image data or, for example, may be acquired on the basis of an action log acquired by a wearable device possessed by the user.

In this manner, because, in the display pattern B, images are displayed in association with photographing locations, the user can see the images along with information as to the locations such as, for example, a travel destination, so that the user can more deeply recognize a situation in which the images are photographed.

Note that the above-described predetermined threshold which becomes a criterion for determining whether or not to employ the display pattern B may be set as appropriate on the basis of the action history of the user. For example, the threshold may be set in accordance with frequency of the user's visit to the location where the images are photographed within a predetermined period, which is obtained on the basis of the action history. For example, even if the location is a park near the user's home, or the like, in the case where the user less frequently goes to the park, the display pattern B may be employed for images photographed at the park. If frequency of the user's visit to the park increases, because there is a possibility that visiting the park may be part of daily life for the user, the display pattern B is not employed and other display patterns can be employed.

However, the above-described frequency of visit to each location may be reset at a predetermined timing. For example, the above-described period for obtaining the frequency may be a predetermined period going back from a current time point and may be updated as needed. Therefore, for example, even a location which the user has frequently visited at some time in the past and which has been exempt from target of the display pattern B once, in the case where the user has visited the location at intervals such as for the first time in a year, the display pattern B may be applied again to the image photographed at the location.

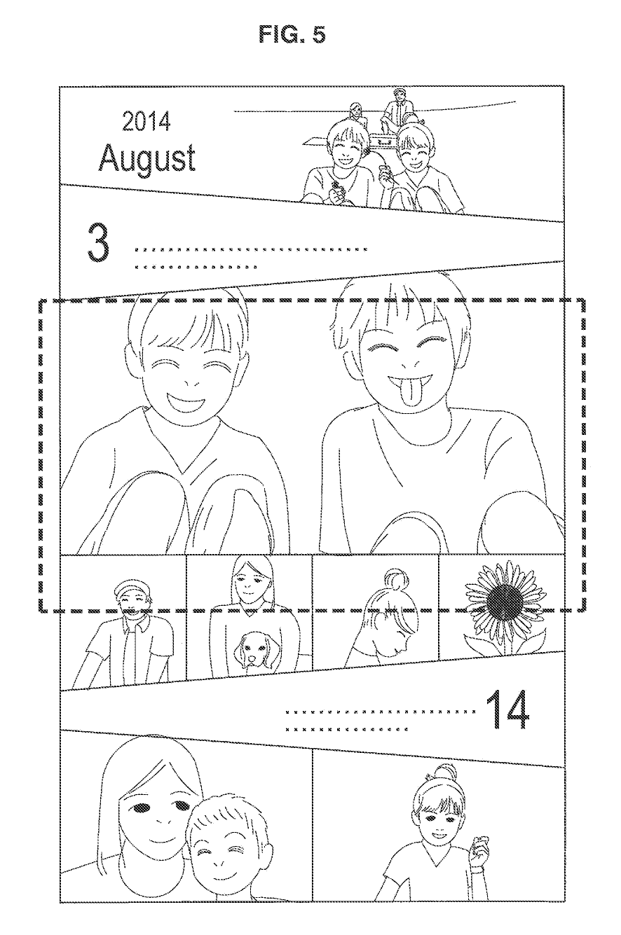

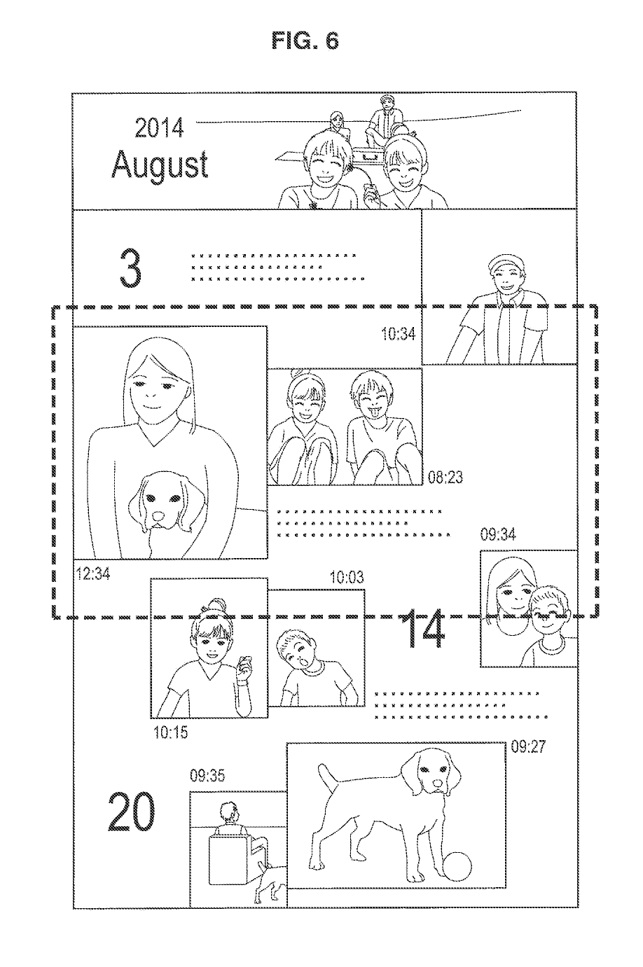

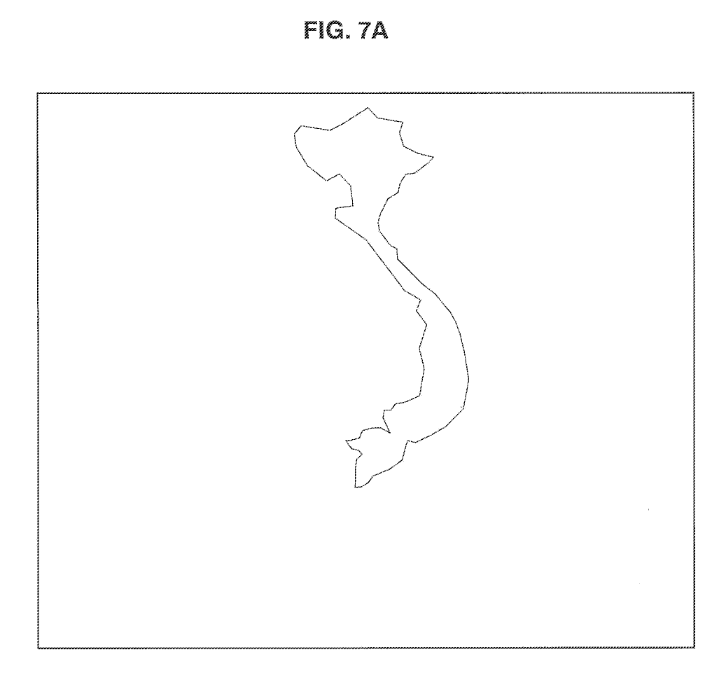

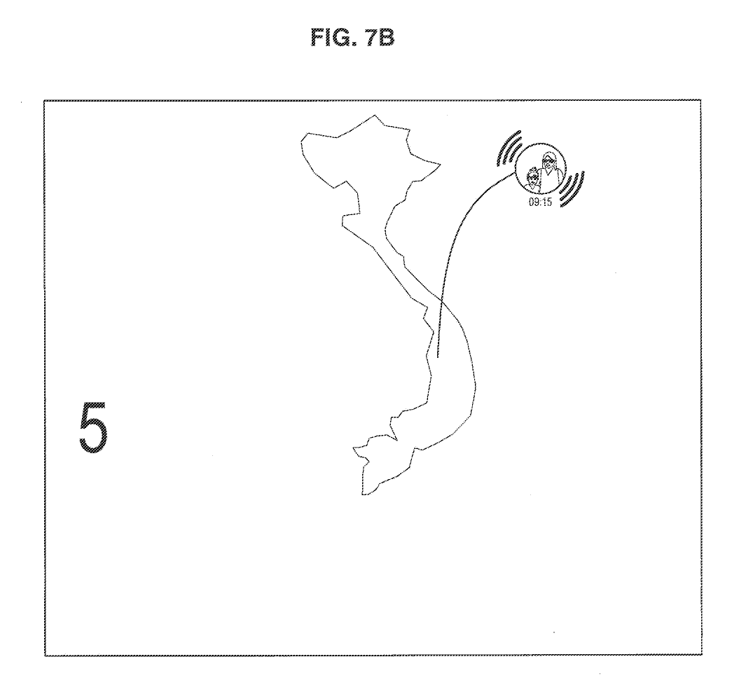

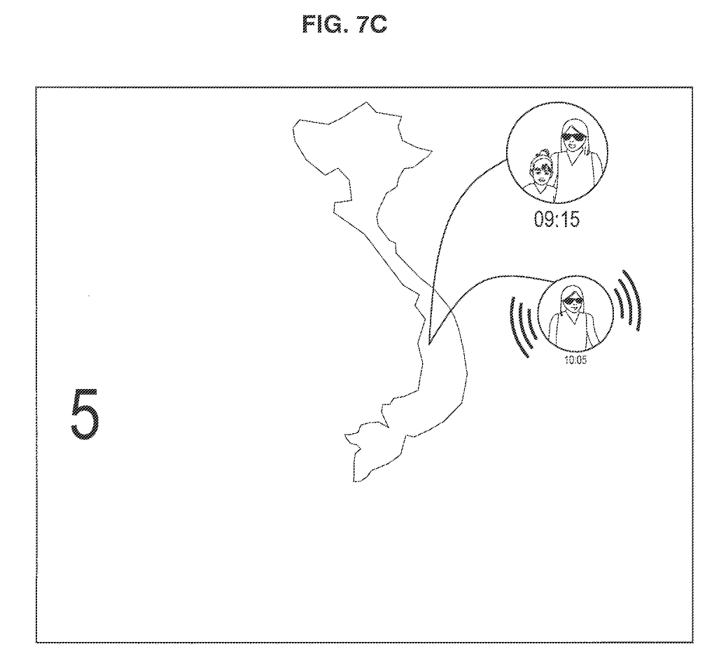

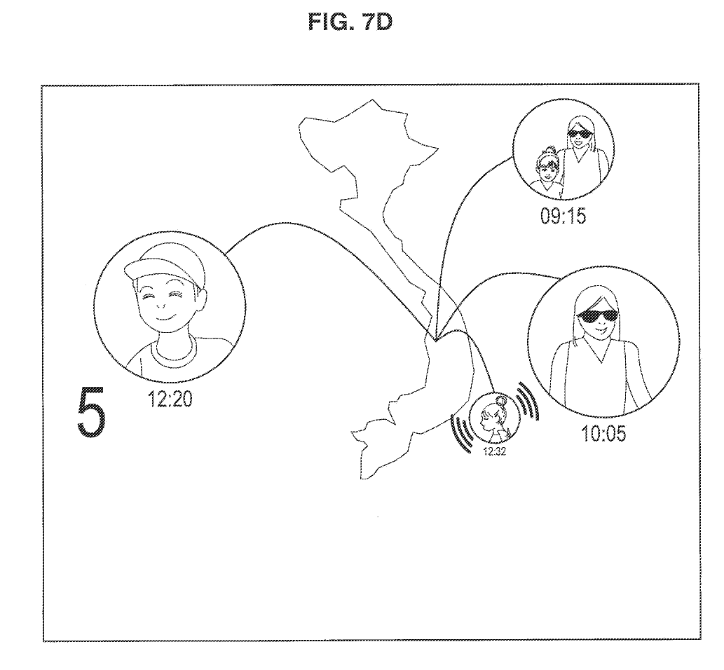

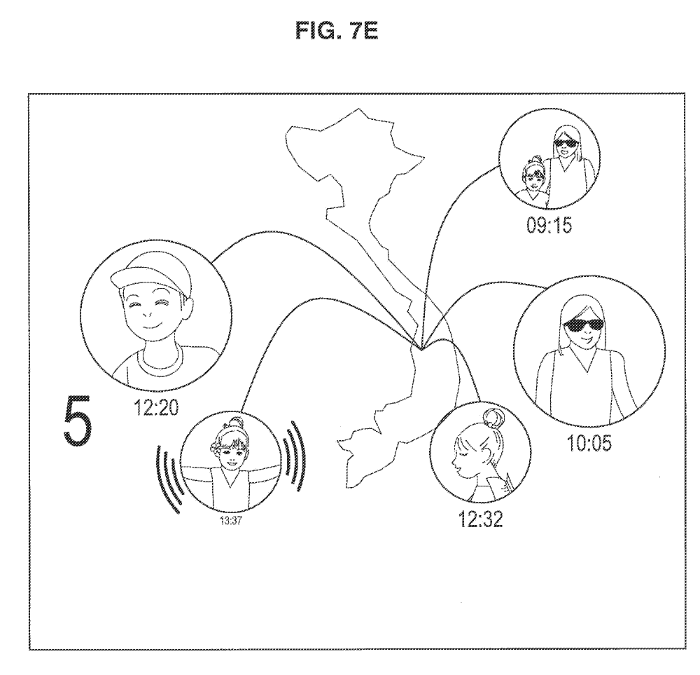

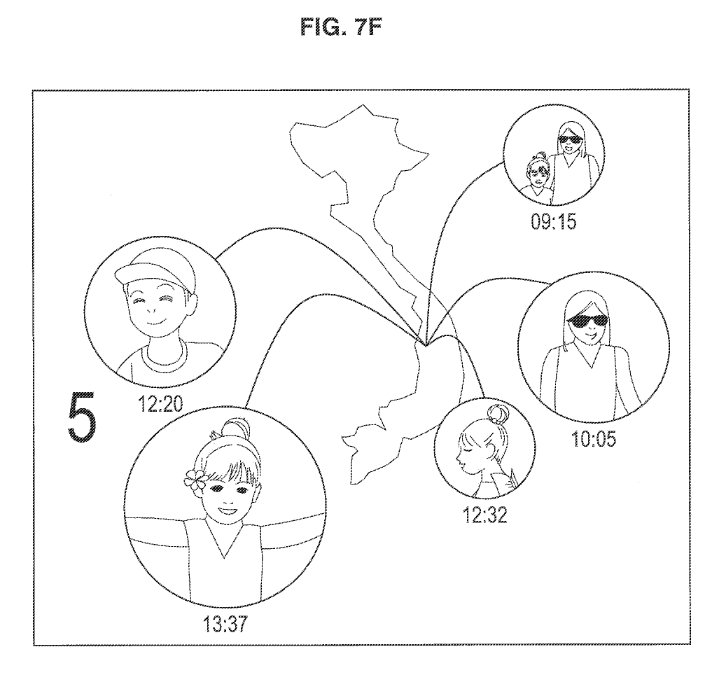

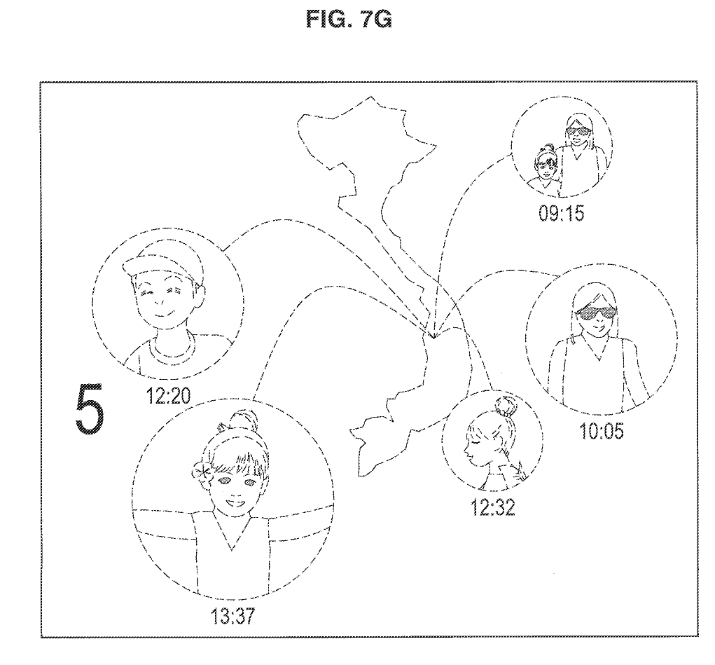

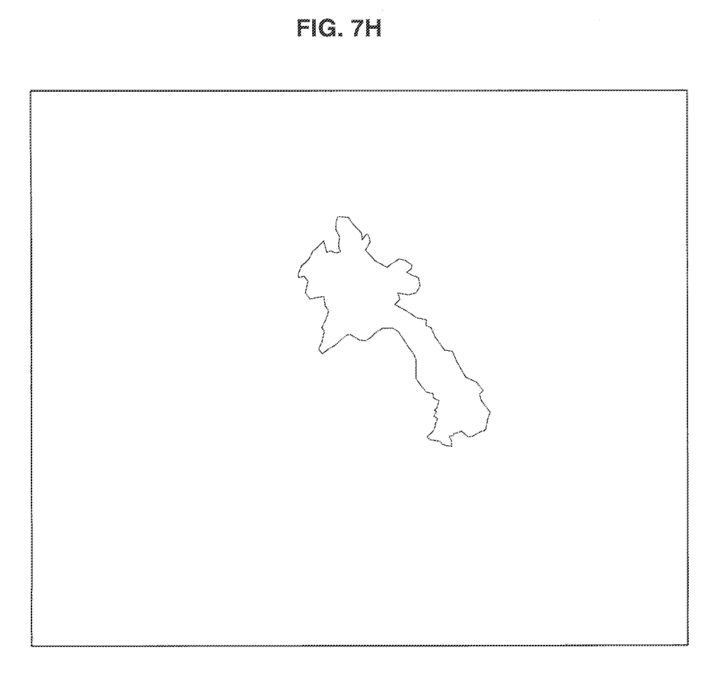

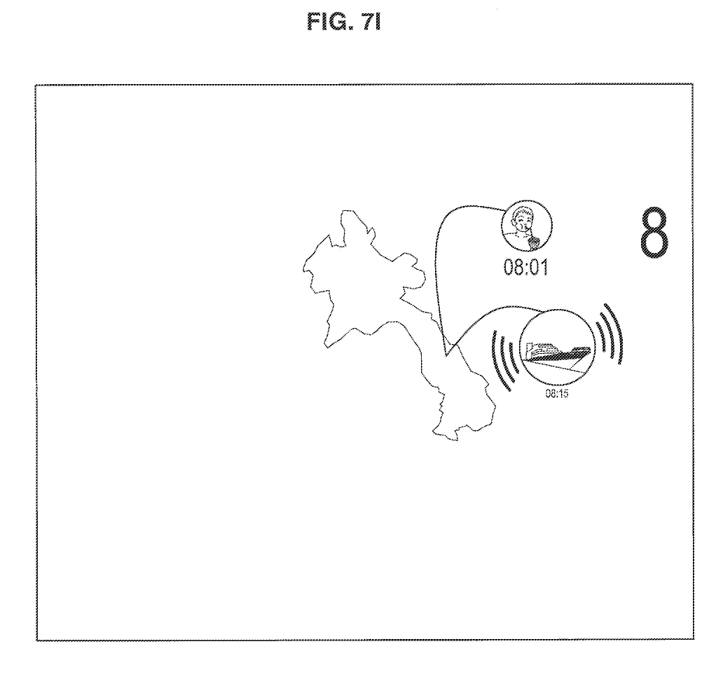

Here, in the display patterns A, C and D, display obtained by extracting part in the vertical direction of display respectively illustrated in FIG. 3, FIG. 5 and FIG. 6 can be presented as is to the user while the display continuously changes in accordance with scrolling operation by the user. However, display in accordance with the display pattern B illustrated in FIG. 4 is merely display illustrated for convenience sake, and, in the display pattern B, display which can be actually presented to the user when scrolling operation is performed is not display obtained by extracting part of the display illustrated in FIG. 4 as is. That is, in the display pattern B, change of display different from other display patterns occurs upon scrolling operation. A display example upon scrolling operation in the display pattern B will be described in detail later with reference to FIG. 7A to FIG. 7I.

(Display pattern C)

The display pattern C will be described with reference to FIG. 5. FIG. 5 is a diagram illustrating an arrangement example of images in the display pattern C. Note that, because the cover image is similar to that illustrated in FIG. 3, detailed description will be omitted.

Referring to FIG. 5, in the display pattern C, some of images photographed at the date are organized and arranged for each date. There are, for example, approximately four or five images for each date. Each image can be displayed so as to occupy a relatively larger region than that in the display pattern A. Further, a group of images is arranged in chronological order from the top to the bottom.

While the display pattern C is similar to the display pattern A in that images are organized and arranged for each date, in the display pattern C, the number of displayed images is smaller than that in the display pattern A. In this manner, the display pattern C can be preferably employed in the case where, for example, the number of pieces of the extracted image data is smaller than a predetermined threshold. In the display pattern C, even in the case where the number of pieces of the extracted image data is small, it is possible to provide display of notifying the user of outline of the event.

Note that, in this event, in order to make up for deficiency of an information amount by images, in the display pattern C, as illustrated, a caption (such as, for example, “birthday of XX” and “went to ZZ on YY”) indicating content of an event occurring at the date may be displayed for each date. The caption may be input by the user who stores the image data in the information processing apparatus 10 or may be automatically generated by the information processing apparatus 10 on the basis of a result of analysis of the image data, position information of the image data, time information of the image data, or the like.

### (Pattern D)

The display pattern D will be described with reference to FIG. 6. FIG. 6 is a diagram illustrating an arrangement example of images in the display pattern D. Note that, because the cover image is similar to that illustrated in FIG. 3, detailed description will be omitted.

Referring to FIG. 6, in the display pattern D, approximately one to three images out of images photographed at the date are organized and arranged for each date. Each image can be displayed so as to occupy a relatively larger region than that in the display pattern A. Further, a group of images are arranged in chronological order from the top to the bottom. Further, a group of images are arranged in chronological order from the top to the bottom.

In the display pattern D, a margin between images occupies a relatively larger region than that in the display pattern A and the display pattern C. In the margin, as with the case of the display pattern C, a caption indicating content of an event occurring at that date is displayed for each date. Because the margin is larger, the number of displayed captions is larger than that in the display pattern C. As with the case of the display pattern C, the captions may be input by the user or may be automatically generated by the information processing apparatus 10.

The display pattern D can be preferably employed, for example, in the case where the number of the extracted images is extremely small, in the case where event clustering is not performed upon extraction of images, or the like. In the pattern D, because captions are respectively added for each of approximately one to three images, even in the case where the number of the extracted images is extremely small or in the case where the images are not classified by events, the user can recognize a situation in which these images are photographed from the captions.

Alternatively, in the case where the captions are automatically generated by the information processing apparatus 10, various kinds of publicly known natural language analysis processing such as parsing is performed on the generated captions, and, in the case where it is judged that content of the captions is meaningful for the user to recognize the situation, the display pattern D may be employed.

In this manner, the display pattern D is a display pattern which can provide information more useful for the user by utilizing captions more positively and presenting to the user captions and images in combination with each other in a balanced manner.

Some examples of the display patterns in the present embodiment have been described above. In the present embodiment, by selecting one of the above-described display pattern A to display pattern D for each event and combining these display patterns, a plurality of images in accordance with each display pattern are continuously displayed. Here, in a typical photobook including page breaks or a slide show, content simply sequentially appears through scrolling operation by the user. Meanwhile, according to the present embodiment, as described above, images can be displayed as gathering of each event. Further, as in the display pattern B, arrangement and representation in accordance with metadata of images (movement of locations of photographs or photographing time) can be realized. In this manner, by realizing expression in accordance with meaning of images, it is possible to convey story of a series of groups of images better to the user who browses the images.

Note that, while, in the above-described examples, one display pattern is determined for one event, the present embodiment is not limited to this example. For example, in a series of event in which the user moves a long distance and, then stays at the destination for several days, the display pattern B may be applied for photographs taken during movement to show the movement, while one of the display pattern A to the display pattern D may be applied to photographs taken at the destination to show the destination (see (5-2. Criterion for image extraction processing and display pattern determination processing) which will be described later).

### (2-2. Display Example Upon Scrolling in Display Pattern B)

A display example upon scrolling in the display pattern B will be described with reference to FIG. 7A to FIG. 7I. FIG. 7A to FIG. 7I are diagrams illustrating display examples upon scrolling in the display pattern B. FIG. 7A to FIG. 7I sequentially illustrate transition of display upon scrolling in the display pattern B illustrated in FIG. 4 in chronological order.

In the display example illustrated in FIG. 4, a photographer takes photographs while traveling over a plurality of countries. Here, an aspect of transition of display which switches from initial display in the display pattern B to display of a group of images photographed in the first country, and from the display of the group of images photographed in the first country to display of a group of images photographed in the second country, will be described.

In the display pattern B, first, only a map of the surrounding area including the photographing location is displayed (FIG. 7A). Then, as display is scrolled, date is displayed, and the respective images are displayed in the order of time at which the images are photographed while the images are gradually enlarged to be predetermined sizes respectively defined for the images (FIG. 7B to FIG. 7F). FIG. 7F illustrates an aspect where scrolling operation is performed by a predetermined amount of movement, and all the images associated with the first map are displayed at predetermined sizes.

If the display is further scrolled from this state, display of the first map and the images associated with the map gradually fades (FIG. 7G), and a map of the second country is displayed in the background (FIG. 7H). Then, by scrolling operation being further performed, respective images are displayed on the map of the second country while the images are gradually enlarged in the order of time at which the images are photographed in a similar manner to FIG. 7B to FIG. 7F (FIG. 7I).

The display example upon scrolling in the display pattern B has been described above with reference to FIG. 7A to FIG. 7I. Note that, in the case where downward scrolling operation is performed and display is switched in chronological order, in the case where the user performs scrolling operation in an opposite direction halfway, display can transition in a direction opposite to a direction of transition of display described above (that is, display can transition so that respective images disappear while the images gradually become smaller).

### (2-3. Display Example Upon Image Selection)

In the above-described display pattern A to display pattern D, a thumbnail of images, images obtained by editing the images (images obtained by trimming only part of the images), or the like, can be displayed. In the present embodiment, by the user who sees images displayed in accordance with one of the display pattern A to the display pattern D selecting an image which the user desires to see in details, the image can be displayed at full size.

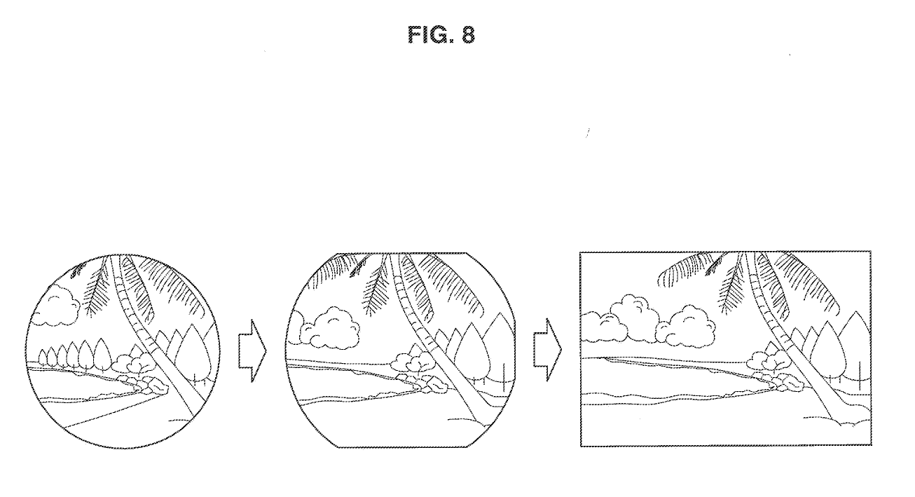

FIG. 8 is a diagram illustrating an example of transition of display when an image is selected by the user. As illustrated in FIG. 8, in the case where an image is selected by the user, the selected image is enlarged, a trimmed portion is restored, and an entire picture of the image can be displayed in the whole area of the display region viewed by the user. In this manner, the user can observe the entire picture of an image by selecting the image which the user is curious about as appropriate among images displayed in accordance with one of the display pattern A to the display pattern D.

### 3. Information Processing Method

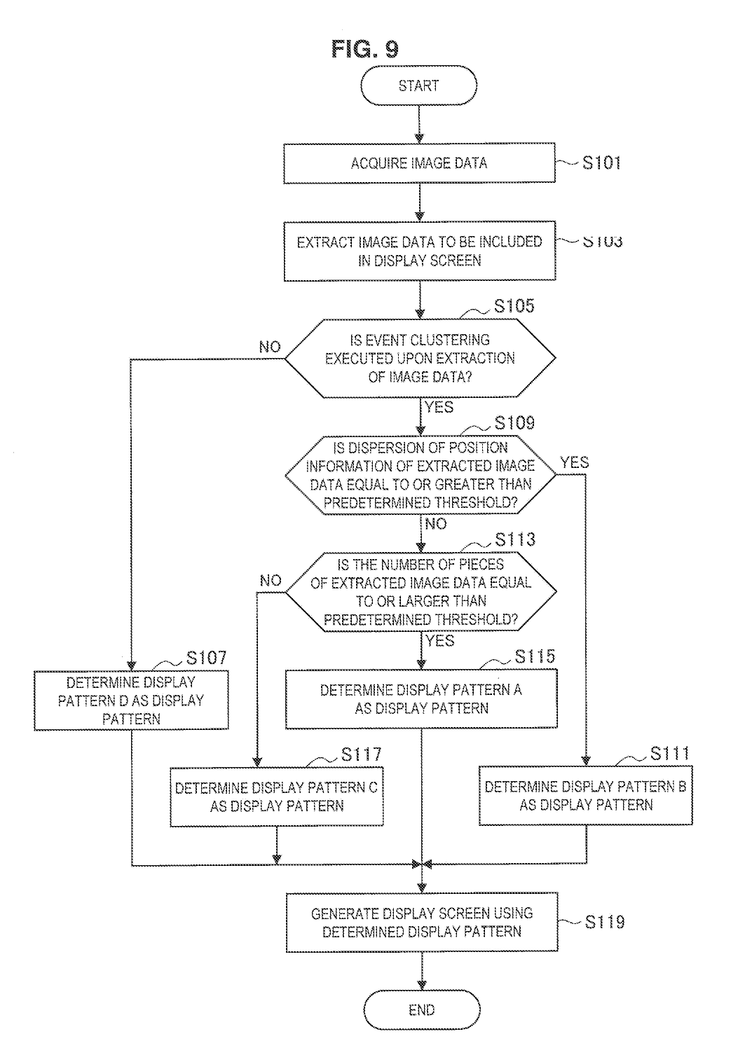

Processing procedure of an information processing method according to the present embodiment will be described with reference to FIG. 9. FIG. 9 is a flowchart illustrating an example of the processing procedure of the information processing method according to the present embodiment. Note that processing in each step illustrated in FIG. 9 corresponds to processing executed in the information processing apparatus 10 illustrated in FIG. 1. Because details of the processing executed in the information processing apparatus 10 have already been described with reference to FIG. 1, in the following description regarding the information processing method according to the present embodiment, only outline of the processing in each step will be described, and description of details of each processing will be omitted.

Referring to FIG. 9, in the information processing method according to the present embodiment, first, image data is acquired (step S101). The processing in step S101 corresponds to the processing executed by the image data acquiring unit 111 illustrated in FIG. 1.

Then, image data to be included in the display screen is extracted among the acquired image data (step S103). For example, in the processing in step S103, the image data is classified through event clustering, and a predetermined number of pieces of image data are extracted in accordance with predetermined priority for each event. The processing in step S103 corresponds to the processing executed by the image data extracting unit 112 illustrated in FIG. 1.

Subsequent processing from step S105 to step S117 corresponds to the processing executed by the display pattern determining unit 113. In step S105, it is judged whether event clustering is executed upon extraction of image data in step S103. In the case where event clustering is not executed, the display pattern D is determined as the display pattern (step S107). Note that, as described above (2. Examples of display pattern), a criterion for judgement of employment of the display pattern D is not limited to whether or not event clustering is executed, and may be content of the automatically generated captions, the number of extracted images, or the like.

On the other hand, in the case where it is judged in step S105 that event clustering is executed, the processing proceeds to step S109. In step S109, it is judged whether a degree of dispersion of position information of the extracted image data is equal to or larger than a predetermined threshold. In the case where the degree of dispersion of the position information is equal to or larger than the predetermined threshold, because it can be considered that the extracted images are photographed at locations distant from each other, the extracted data is likely to include image data photographed at a location away from an activity range of daily life of the user, such as, for example, while traveling. Therefore, in this case, the display pattern B is determined as the display pattern (step S111).

On the other hand, in the case where it is judged in step S109 that the degree of dispersion of position information is smaller than the predetermined threshold, the processing proceeds to step S113. In step S113, it is judged whether the number of pieces of the extracted image data is equal to or larger than a predetermined threshold. The threshold is, for example, “10”. However, the present embodiment is not limited to this example, and the threshold may be set as appropriate by a designer, the user, or the like, of the information processing apparatus 10, while specific arrangement of images in the display pattern A and the display pattern C is taken into account.

In the case where the number of pieces of the extracted image data is equal to or larger than the predetermined threshold, the display pattern A is determined as the display pattern (step S115). In the case where the number of pieces of the extracted image data is smaller than the predetermined threshold, the display pattern C is determined as the display pattern (step S117).

In the case where event clustering is performed in step S105, and image data is extracted for each event, processing from step S109 to step S117 is performed for each event, and the display pattern is determined for each event.

If the display pattern (for each event) is determined in step S107, step S111, step S115 or step S117, the processing proceeds to step S119. In step S119, a display screen is generated using the determined display pattern. Specifically, in step S119, by regions in which images are arranged in accordance with each determined display pattern being arranged from the top to the bottom in chronological order, a display screen in which groups of images are continuously disposed in accordance with each display pattern is generated. Of course, a display screen may be configured with groups of images disposed in accordance with only one type of display pattern. Note that the processing in step S119 corresponds to the processing executed by the display screen generating unit 114 illustrated in FIG. 1.

The processing procedure of the information processing method according to the present embodiment has been described above with reference to FIG. 9.

### 4. Application Example

An application example of the information processing apparatus 10 according to the present embodiment described above will be described. For example, the information processing apparatus 10 can be preferably applied to service in which images (such as photographs) stored by one user are automatically organized and edited and edited image collection (an album if the images are photographs) is delivered to the other user (hereinafter, in the case where image data is photograph data, the service will be referred to as photo delivery service). In the following description, a system configuration and UIs provided to the user when the photo delivery service is utilized in the case where the information processing apparatus 10 is applied to the photo delivery service will be specifically described.

### (4-1. System Configuration)

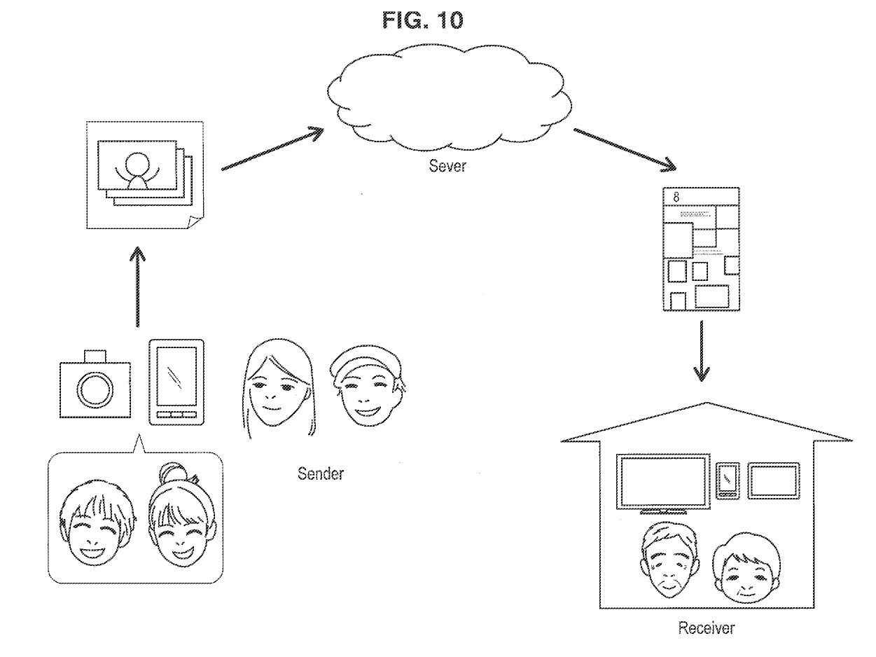

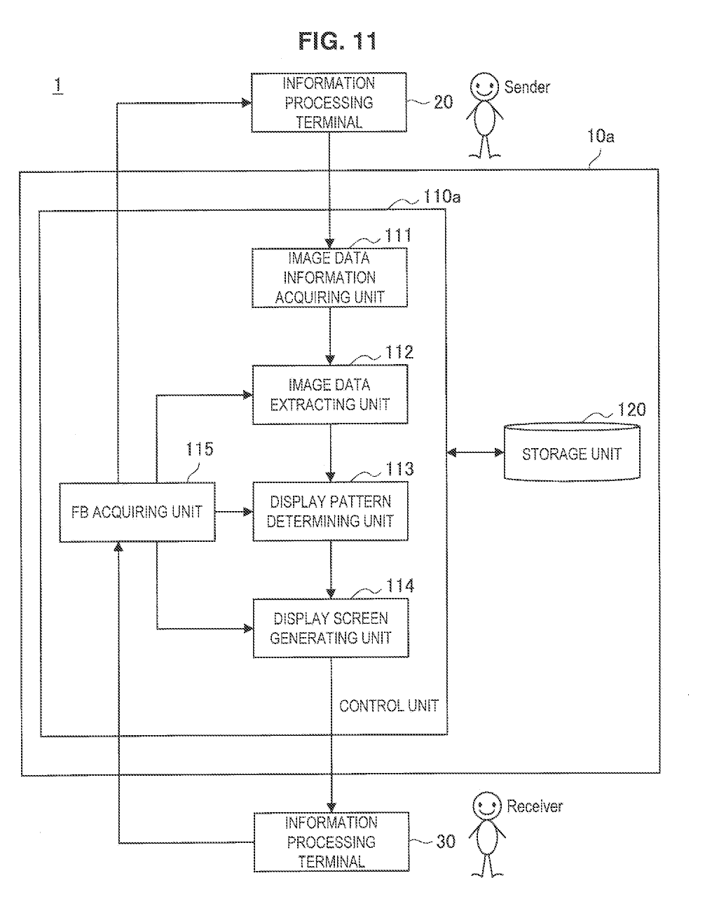

A system configuration in the case where the information processing apparatus 10 according to the present embodiment is applied to the photo delivery service will be described with reference to FIG. 10 and FIG. 11. FIG. 10 is a diagram illustrating outline of the photo delivery service to which the information processing apparatus 10 according to the present embodiment can be applied. FIG. 11 is a block diagram illustrating a functional configuration of the system in the case where the information processing apparatus 10 according to the present embodiment is applied to the photo delivery service.

First, outline of the photo delivery service to which the information processing apparatus 10 according to the present embodiment can be applied will be described with reference to FIG. 10. As illustrated in FIG. 10, in the photo delivery service, one user takes photographs using a smartphone, a digital camera, or the like, and stores the photographs, for example, in a server on a network. The server, which corresponds to the above-described information processing apparatus 10, edits the stored photographs as appropriate and generates a photo album (corresponding to the display screen generated by the above-described display screen generating unit 114) in which, for example, photographs are organized for each month. The server delivers the generated photo album (that is, information as to the display screen) to another user. The another user can browse the photo album using, for example, a PC, a smartphone, a tablet, a TV apparatus which has a network connection function, or the like.

In this manner, according to the photo delivery service, a photo album in which photographs taken by one user are edited is delivered to another user regularly such as, for example, once a month. In the following description, a user who takes photographs and stores the photographs in the server will be also referred to as a sender, and a user to whom the photo album is delivered will be also referred to as a receiver.

Further, the photo delivery service may include a function of notifying the sender of a favorite photograph selected among the browsed photographs by the receiver. According to this function, because the sender can know reaction of the receiver who browses the photo album, the sender can take photographs while referring to the reaction of the receiver when the sender takes photographs for generating a photo album to be delivered next time.

Further, information as to the favorite photograph selected by the receiver may be reflected upon generation of a photo album to be delivered next time. For example, when a photo album to be delivered next time is generated, photographs including a person included in the favorite photograph may be preferentially extracted.

As a typical utilization example of the photo delivery service, utilization between families who live at locations away from each other can be assumed. For example, in the case where grandparents, and their child and grandchildren live away from each other, the child who is a sender stores photographs of his/her children (that is, grandchildren viewed from the grandparents) taken in usual life and photographs of life of his/her family in a server. The grandparents who are receivers can confirm how their child and grandchildren who live away are by browsing a photo album which is regularly delivered.

Further, for example, in the case where the grandparents browse a photo album and select a photograph of grandchildren as a favorite photograph, their child can be notified of the selection. Their child who receives the notification can give a response such as taking more photographs of their children in photographing in the future so that a photo album to be delivered next time includes more photographs of their children. By this means, the grandparents can browse more photographs of their grandchildren in the next photo album.

A functional configuration of a system in the case where the information processing apparatus 10 according to the present embodiment is applied to the photo delivery service will be described next with reference to FIG. 11. Referring to FIG. 11, a system 1 is configured with an information processing apparatus 10a, an information processing terminal 20 at a sender side, and an information processing terminal 30 at a receiver side.

The information processing terminals 20 and 30 are, for example, desktop PCs, tablet PCs, smartphones, wearable devices, or the like. However, the types of the information processing terminals 20 and 30 are not limited to these examples, and the information processing terminals 20 and 30 may be any kind of apparatus if the information processing terminals 20 and 30 have at least a function of connecting to a network and a display function for displaying photographs. That is, while not illustrated, the information processing terminals 20 and 30 have functions of a communication unit for exchanging various kinds of information with the information processing apparatus 10a, a display unit for visually displaying various kinds of information, a display control unit for controlling operation of the display unit, or the like. Because these functions may be similar to functions provided at a typical existing information processing terminal, detailed description thereof will be omitted here.

The sender stores (transmits) photograph data in the information processing apparatus 10a via the information processing terminal 20. Note that the information processing terminal 20 itself may have a camera, and the sender may directly transmit photographs taken by the information processing terminal 20 to the information processing apparatus 10.

Further, the sender can browse the photo album generated by the information processing apparatus 10a via the information processing terminal 20. In this event, a photo album before being delivered may be designed so that the sender can edit the photo album, for example, can replace photographs, or the like, via the information processing terminal 20.

The sender browses the regularly delivered photo album via the information processing terminal 30. Further, the receiver can select a favorite photograph from the photo album via the information processing terminal 30 and can feed back (FB) the result to the information processing apparatus 10a.

Note that a favorite photograph may be explicitly selected by the sender by, for example, a function for selecting a favorite photograph being provided at the photo album. In this case, the function may be set so that a favorite degree can be quantitatively selected by, for example, evaluating a photograph on a five-point scale, or the like.

Alternatively, selection of a favorite photograph may be automatically detected in accordance with behavior of the receiver who browses the photo album. For example, the information processing terminal 30 can automatically select a favorite photograph in accordance with whether or not a photograph is selected during browsing of the photo album (that is, whether or not a photograph is browsed at full size) and whether or not scrolling of the photo album is stopped and a photograph is displayed for a period equal to or longer than a predetermined period in a display region of the information processing terminal 30. Further, a function of detecting the line of sight of the receiver may be provided at the information processing terminal 30, and the information processing terminal 30 may automatically select a photograph on which the line of sight of the receiver is focused for a period equal to or longer than the predetermined period as a favorite photograph. In the case where the information processing terminal 30 automatically selects a favorite photograph, a favorite degree may be quantitatively evaluated on the basis of, for example, the number of times the photograph is selected, a period during which the photograph is displayed, a period during which the line of sight is directed to the photograph, or the like.

The information processing apparatus 10a corresponds to the information processing apparatus 10 described with reference to FIG. 1. The information processing apparatus 10a receives the photograph data from the information processing terminal 20 which is the sender and generates a photo album. The information processing apparatus 10a then delivers the generated photo album to the information processing terminal 30 which is the receiver. Further, the information processing apparatus 10a can receive a result of FB for the favorite photograph from the information processing terminal 30 which is the receiver and notify the information processing terminal 20 which is the sender of the result of the FB.

Note that the information processing apparatus 10a corresponds to an apparatus to which a function of an FB acquiring unit 115 which will be described later is added to the information processing apparatus 10 described with reference to FIG. 1. Therefore, in the following description regarding a functional configuration of the information processing apparatus 10a, detailed description of the functions which have already been described will be omitted, and points different from the above-described information processing apparatus 10 will be mainly described.

The information processing apparatus 10a includes a control unit 110a and a storage unit 120 as its functions. Further, the control unit 110a has an image data acquiring unit 111, an image data extracting unit 112, a display pattern determining unit 113, a display screen generating unit 114 and an FB acquiring unit 115 as its functions.

Functions of the storage unit 120, the image data acquiring unit 111, the image data extracting unit 112, the display pattern determining unit 113 and the display screen generating unit 114 are substantially similar to the functions in the information processing apparatus 10. However, in the information processing apparatus 10a, the image data acquiring unit 111 receives photograph data from the information processing terminal 20, and the display screen generating unit 114 transmits information as to the generated display screen (that is, information as to the photo album) to the information processing terminal 30. Further, the display pattern determining unit 113 and the display screen generating unit 114 generate a photo album to notify the sender of information as to the favorite photograph which will be described later.

The FB acquiring unit 115 acquires information as to the favorite photograph selected from the photo album from the information processing terminal 30. Detection of the favorite photograph can be executed as appropriate by the information processing terminal 30 through the above-described procedure.

The FB acquiring unit 115 provides the information as to the favorite photograph to the image data extracting unit 112, the display pattern determining unit 113 and the display screen generating unit 114. The image data extracting unit 112 can change a criterion for judgement used when photograph data for generating a photo album to be delivered next time is extracted, on the basis of the information as to the favorite photograph. For example, the image data extracting unit 112 changes a criterion for judgement used when photograph data is extracted so that more pieces of photograph data in which a person included in the favorite photograph appears are extracted.

Further, the display pattern determining unit 113 and the display screen generating unit 114 can correct the delivered photo album and can newly generate a photo album to be notified to the sender on the basis of the information as to the favorite photograph. For example, the display pattern determining unit 113 and the display screen generating unit 114 highlight the favorite photograph selected by the receiver in the photo album. Highlighting can be, for example, display of the favorite photograph while making the favorite photograph larger than other photographs, addition of a frame to the favorite photograph, or the like.

Further, the FB acquiring unit 115 transmits the information as to the favorite photograph to the information processing terminal 20 which is the sender. For example, the FB acquiring unit 115 delivers the photo album to be notified generated by the display pattern determining unit 113 and the display screen generating unit 114 to the information processing terminal 20. The sender who browses the photo album to be notified can easily confirm the receiver's favorite photograph by, for example, confirming the highlighted photograph.

The configuration of the system 1 has been described above.

### (4-2. Examples of UI)

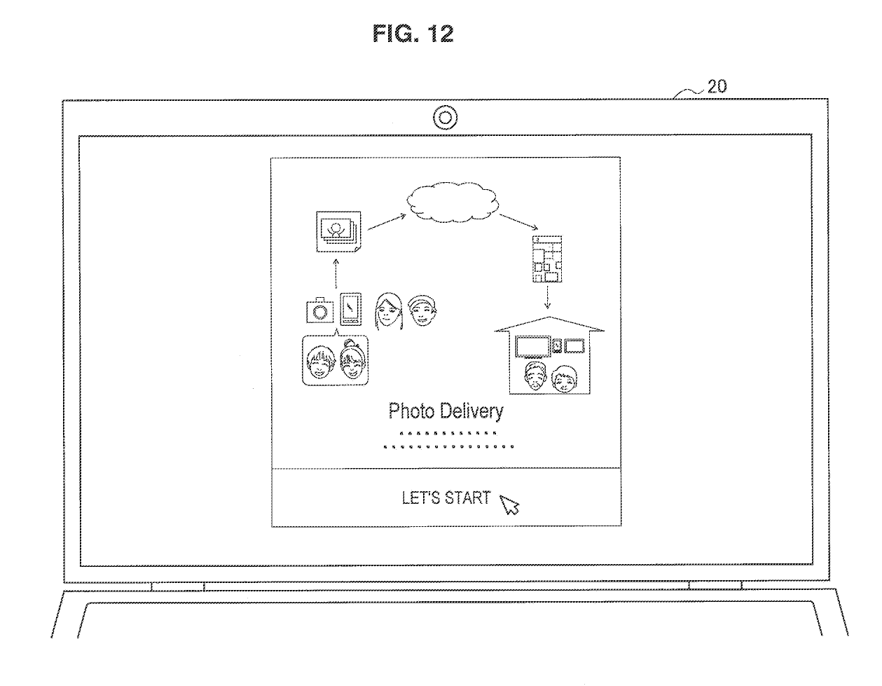

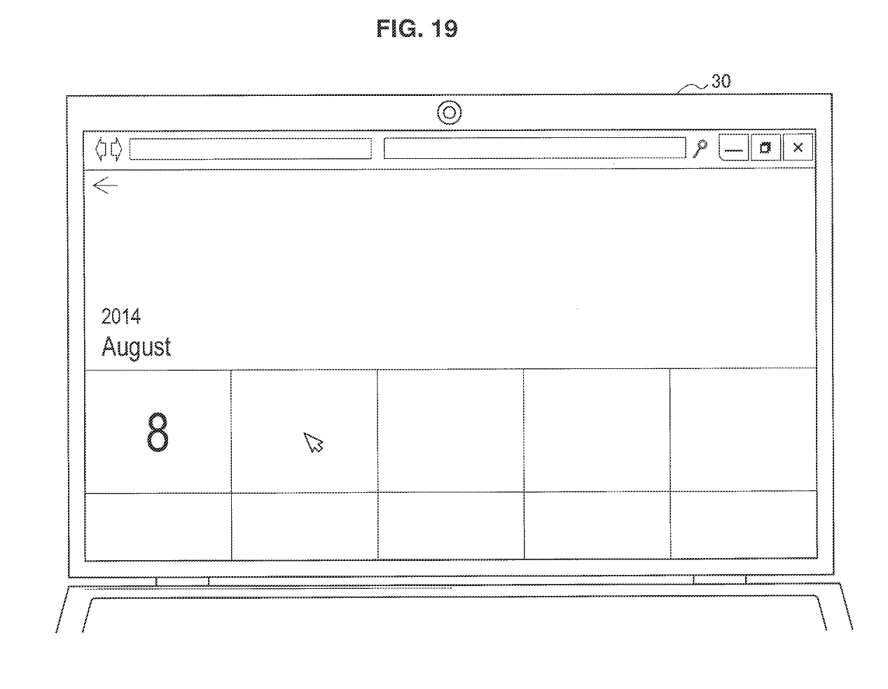

Examples of UIs provided to the sender and the receiver in the system described above will be described with reference to FIG. 12 to FIG. 24. FIG. 12 to FIG. 18 and FIG. 24 illustrate display screens relating to the UI provided to the sender, that is, display screens which can be displayed at the information processing terminal 20. Further, FIG. 19 to FIG. 23 illustrate display screens relating to the UI provided to the receiver, that is, display screens which can be displayed at the information processing terminal 30. These display screens relating to various kinds of UIs are generated by the information processing apparatus 10a and can be displayed to the user via display units of the information processing terminals 20 and 30 by being transmitted to the information processing terminals 20 and 30.

### (4-2-1. Upon Generation of Photo Album (Sender Side))

### (Upon Setup)

FIG. 12 to FIG. 16 are diagrams illustrating display screens relating to the UI provided to the sender upon setup of the photo delivery service. Here, a display example in the case where the information processing terminal 20 is a PC is illustrated as an example. In the case where the information processing terminal 20 is a PC, a UI assuming that various kinds of operation is performed by the sender selecting a graphical user interface (GUI) part within a display region through a pointer, or the like, using, for example, a mouse, can be provided. Note that, it is assumed that, upon setup, photograph data which has been photographed and accumulated has already been stored in the information processing apparatus 10a by the sender as needed.

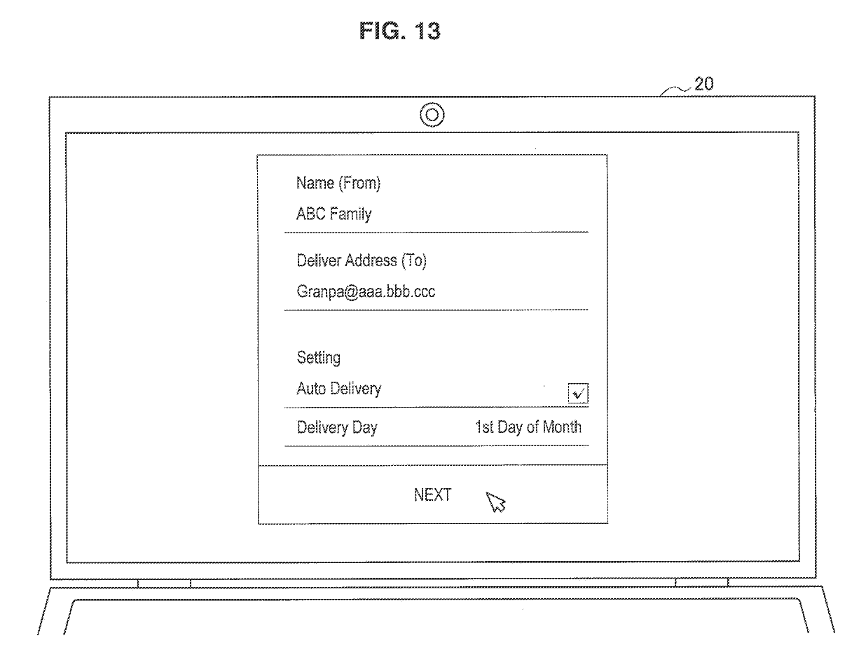

When the system 1 is utilized, first, as illustrated in FIG. 12, a screen indicating outline of the photo delivery service to the sender is displayed. When the sender clicks an icon indicating “LET'S START”, the screen transitions to a screen for inputting various kinds of information relating to delivery as illustrated in FIG. 13. The sender can input information such as, for example, name indicating a delivery source (name of family), e-mail address of a delivery destination and delivery date via the display screen.

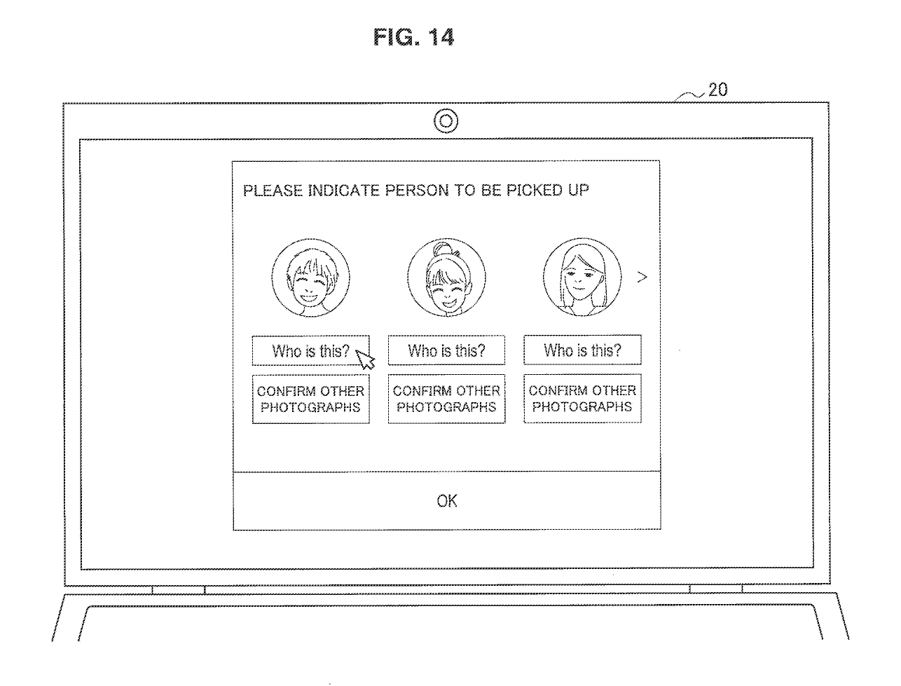

When the sender clicks an icon indicating “NEXT”, the screen transitions to a screen for selecting a person to be included in the photo album as illustrated in FIG. 14. In the screen, typical photographs indicating the faces of the persons are displayed, and entry fields for inputting name of the persons are displayed. The photographs of the faces are, for example, extracted from the stored photographs through face recognition processing and person recognition processing by the information processing apparatus 10a. The sender inputs name as appropriate in accordance with the photographs and associates the faces with the name.

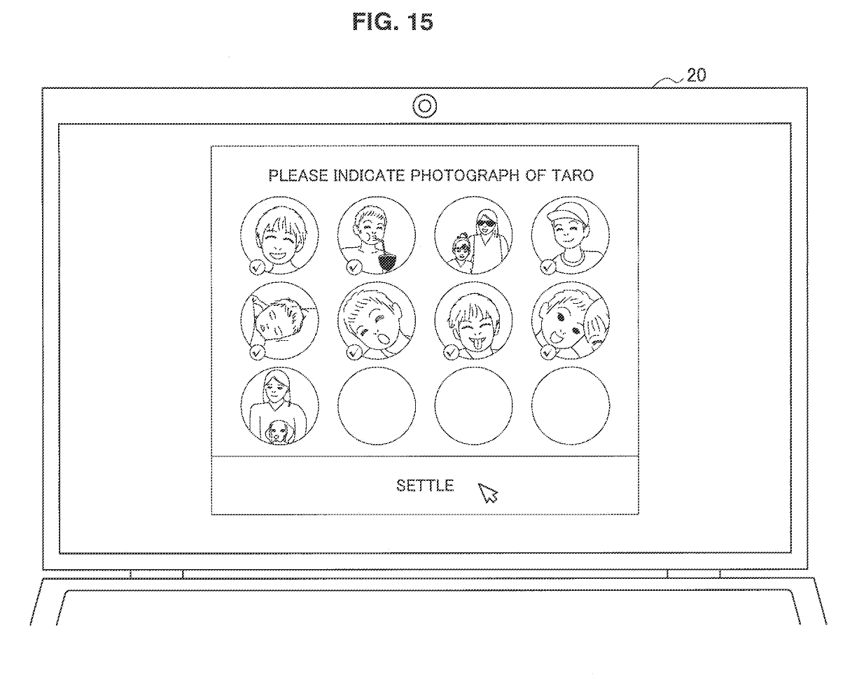

When the sender clicks an icon (an icon indicating “OK”) indicating that input of name is finished, the screen transitions to a screen for associating the face with the name in more detail as illustrated in FIG. 15. In the screen, for example, for one person (in the illustrated example, “Taro”) among persons whose name is input in the display screen illustrated in FIG. 14, a plurality of candidates for the photograph of the face which are judged as photographs indicating the person by the information processing apparatus 10a can be displayed. The sender selects a photograph indicating the person among these photographs. Because face recognition processing and person recognition processing by the information processing apparatus 10a do not always have to be performed with high accuracy, by such detailed association being performed, it is possible to improve accuracy of the processing in subsequent processing of extracting photograph data so that the designated person is included.

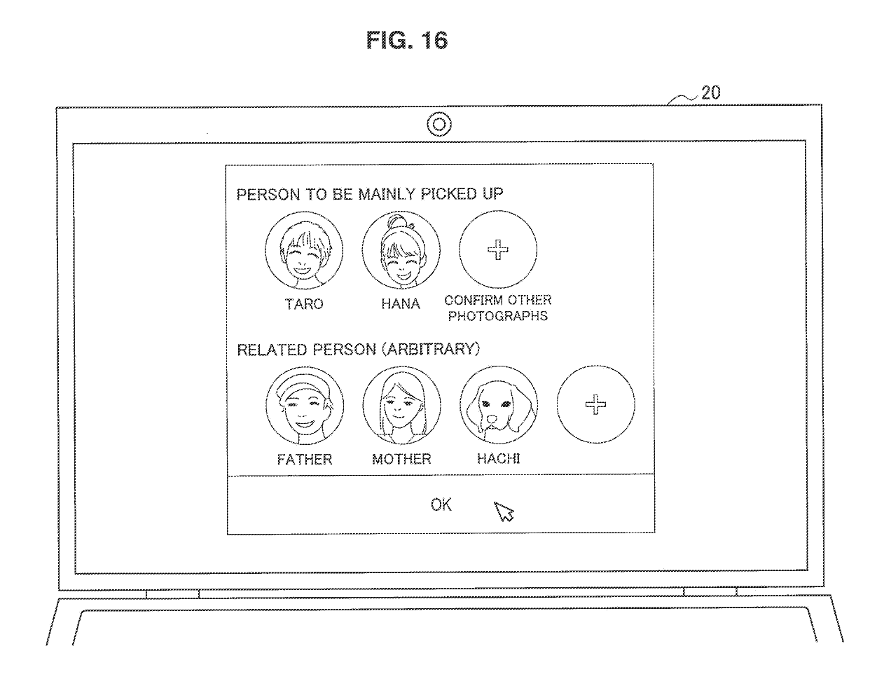

When the sender clicks an icon (an icon indicating “SETTLE”) indicating that selection of a photograph is finished, the screen transitions to a screen for selecting a person to be included in the photo album in more detail as illustrated in FIG. 16. In the screen, the sender can select a person to be mainly extracted when the photograph data to be included in the photo album is extracted and a person relating to the person to be mainly extracted.

Setup is finished as described above. The image data extracting unit 112 of the information processing apparatus 10a sets priority in accordance with a selection result on the display screen illustrated in FIG. 16 and extracts photograph data in accordance with the priority. Thereafter, the display pattern determining unit 113 and the display screen generating unit 114 execute the above-described processing to generate a photo album.

Here, the information processing terminal 20 does not have to be a PC, and, for example, may be a device having a touch panel, such as a smartphone. In the case where the information processing terminal 20 is a device having a touch panel, a UI assuming that various kinds of operation is performed by the sender selecting a GUI part within a display region using an operation body such as, for example, a finger, can be provided.

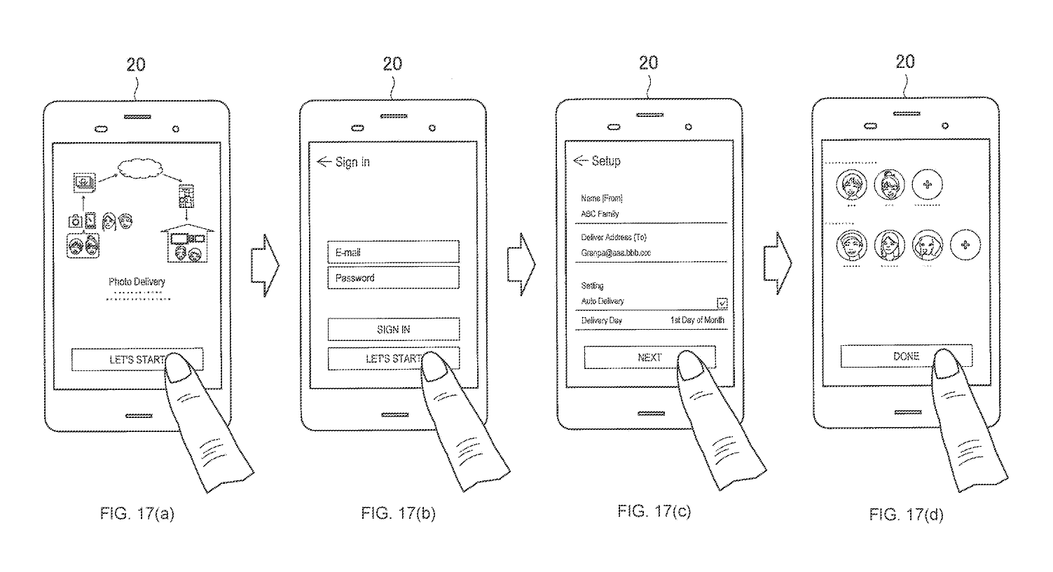

FIG. 17 illustrates an example of the UI. FIG. 17 is a diagram illustrating a display screen relating to a UI provided upon setup of the photo delivery service in the case where the information processing terminal 20 is a device having a touch panel. Note that FIG. 17 illustrates display in the case where the information processing terminal 20 is a smartphone as an example.

The display screen illustrated in FIG. 17 is substantially the same as the display screen in the case where the information processing terminal 20 is a PC illustrated in FIG. 12 to FIG. 16 except that selection operation by the user is changed from click operation using a mouse to tap operation using a finger.

That is, as illustrated in FIG. 17, upon setup, first, a screen explaining outline of the photo delivery service (corresponding to the display screen illustrated in FIG. 12) is displayed ((a)). Then, a screen for inputting various kinds of information relating to delivery (corresponding to the display screen illustrated in FIG. 13) is displayed ((c)). Note that, while illustration is omitted in FIG. 12 to FIG. 16, before the screen transitions to the screen for inputting various kinds of information relating to delivery, as illustrated in FIG. 17, a screen for signing in to associate the sender with the photo delivery service may be displayed ((b)).

When input of various kinds of information relating to delivery is finished, the screen transitions to a screen for selecting a person to be included in the photo album (corresponding to the display screen illustrated in FIG. 16) ((d)). Note that, while illustration is omitted in FIG. 17, a screen for associating photographs of the faces with name as illustrated in FIG. 14 and FIG. 15 may be displayed as appropriate.

### (Upon Confirmation of Photo Album)

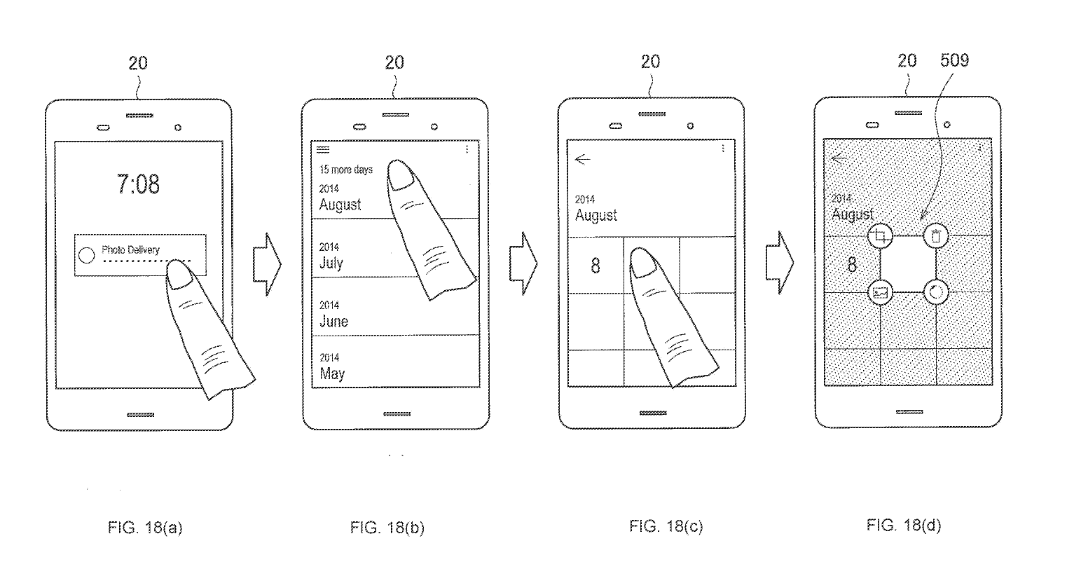

In the system 1, a function for allowing the sender to confirm content of a photo album before the photo album is delivered when the photo album is generated by the information processing apparatus 10a, may be provided. FIG. 18 is a diagram illustrating a display screen relating to a UI provided when the photo album before being delivered is confirmed. Here, while a display example in the case where the information processing terminal 20 is a device having a touch panel (specifically, a smartphone) is described as an example, also in the case where the information processing terminal 20 is a PC, a similar screen may be displayed although only an operation method by the sender is different.

Referring to FIG. 18, for example, the information processing terminal 20 is notified of information indicating that the photo album is generated and information indicating days until the photo album is delivered ((a)). A timing at which the notification is made may be set as appropriate by the sender, for example, set at a week before the delivery date, the day before the delivery date, or the like.

The sender can sign in to the photo delivery service and access the screen on which a list of titles of the photo albums generated for each month is displayed to confirm the generated photo albums ((b)). In the illustrated example, a photo album indicated with “2014 August” at the top of the list has not been delivered yet, and the days until the delivery date are displayed on the list. Content of the corresponding photo album can be displayed by the sender scrolling the list and selecting a title of the photo album whose content the sender desires to confirm from the list.

For example, it is assumed that the sender selects “2014 August” to confirm the photo album before being delivered. In this case, as illustrated, a photo album of August, 2014 is displayed ((c)). The sender can browse and confirm content of the photo album while scrolling display in a vertical direction.

Further, on the screen, the sender can edit the photo album as appropriate. For example, when a photograph included in the photo album is selected, an icon 509 for editing the photograph is displayed ((d)). For example, as illustrated, the icons 509 indicating trimming, deletion, change of brightness, rotation, or the like, can be respectively displayed at four corners of the selected rectangular photograph. The sender can delete the photograph and include another photograph instead, or perform various kinds of editing processing (such as, for example, change of a range of trimming, change of brightness and rotation) on the photograph by selecting these icons 509 as appropriate. Note that types of icons (that is, types of editing processing to be performed on the photograph) are not limited to this example, and various kinds of processing typically performed when a photograph is edited can be executed.

In the case where a photo album is edited by the sender, a photo album in which the edited content is reflected is stored in the information processing apparatus 10a as the latest photo album. Then, the latest photo album is delivered to the receiver on the set delivery date.

The UI provided to the sender upon generation of the photo album has been described above.

### (4-2-2. Upon Browsing of Photo Album (Receiver Side))

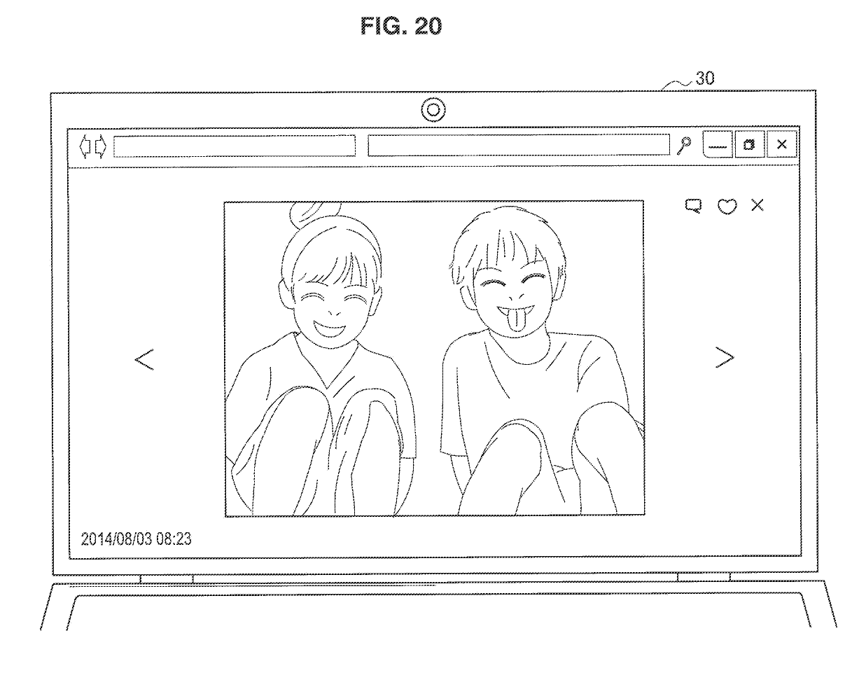

FIG. 19 and FIG. 20 are diagrams illustrating display screens relating to the UI provided to the receiver upon browsing of the photo album. Here, a display example in the case where the information processing terminal 30 is a PC is illustrated as an example. In the case where the information processing terminal 30 is a PC, a UI assuming that various kinds of operation is performed by the receiver selecting a GUI part within the display region through a pointer, or the like, using, for example, a mouse, can be provided.

When the photo album is delivered, for example, an e-mail indicating that the photo album has been delivered is transmitted from the information processing apparatus 10a to the information processing terminal 30 which is the receiver side. The body of the e-mail includes, for example, a link, and a browser for browsing the photo album is activated by the receiver selecting the link.

FIG. 19 illustrates an aspect where the browser is activated and the photo album is displayed on the display screen of the information processing terminal 30. The receiver can browse and confirm content of the photo album while scrolling display in a vertical direction. When the receiver selects one of photographs in the photo album, as illustrated in FIG. 20, the selected photograph is enlarged and displayed at full size.

Here, the information processing terminal 30 does not have to be a PC, and may be a device having a touch panel, such as, for example, a tablet PC. In the case where the information processing terminal 30 is a device having a touch panel, a UI assuming that various kinds of operation is performed by the receiver selecting a GUI part within the display region using an operation body such as, for example, a finger, can be provided.

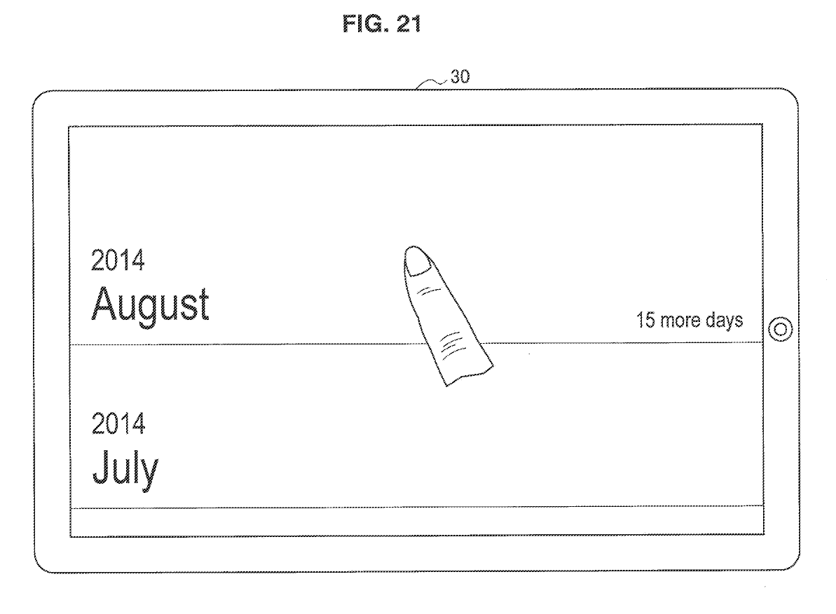

FIG. 21 to FIG. 23 illustrate examples of the UI. FIG. 21 to FIG. 23 are diagrams illustrating display screens relating to the UI provided to the receiver upon browsing of the photo album in the case where the information processing terminal 30 is a device having a touch panel. Note that FIG. 21 to FIG. 23 illustrate display in the case where the information processing terminal 30 is a tablet PC as an example.

The display screens illustrated in FIG. 21 to FIG. 23 are substantially the same as the display screens in the case where the information processing terminal 30 is a PC illustrated in FIG. 19 and FIG. 20 except that operation by the user is changed from operation using a mouse to operation via a touch panel using a finger, or the like.

That is, for example, a browser for browsing the photo album is activated by the receiver selecting a link included in an e-mail which notifies the receiver of delivery of the photo album. While illustration has been omitted in the case of a PC described above, when the browser is activated and a screen for browsing the photo album is displayed at the information processing terminal 30, first, as illustrated in FIG. 21, a screen indicating a list of titles of photo albums generated for each month may be displayed. Content of the corresponding photo album can be displayed by the receiver scrolling the list and selecting a title of a photo album whose content the receiver desires to confirm from the list.

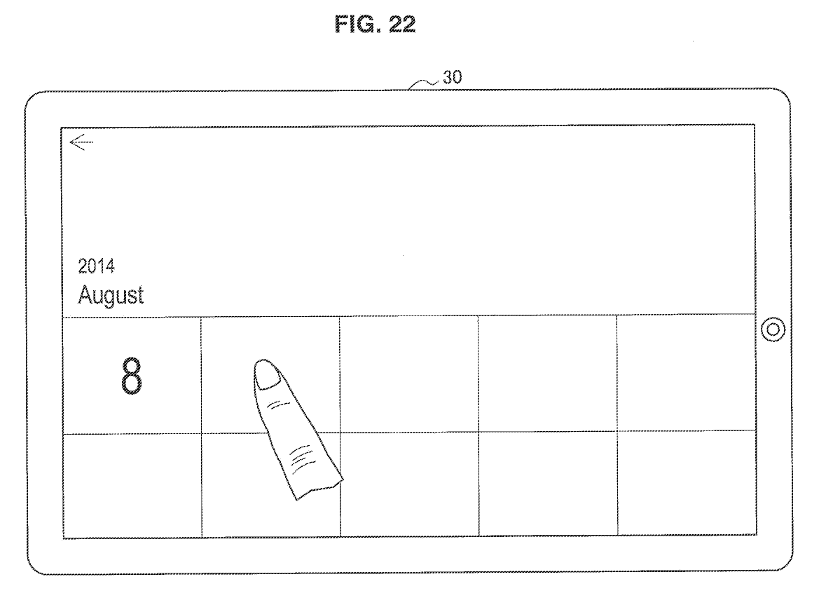

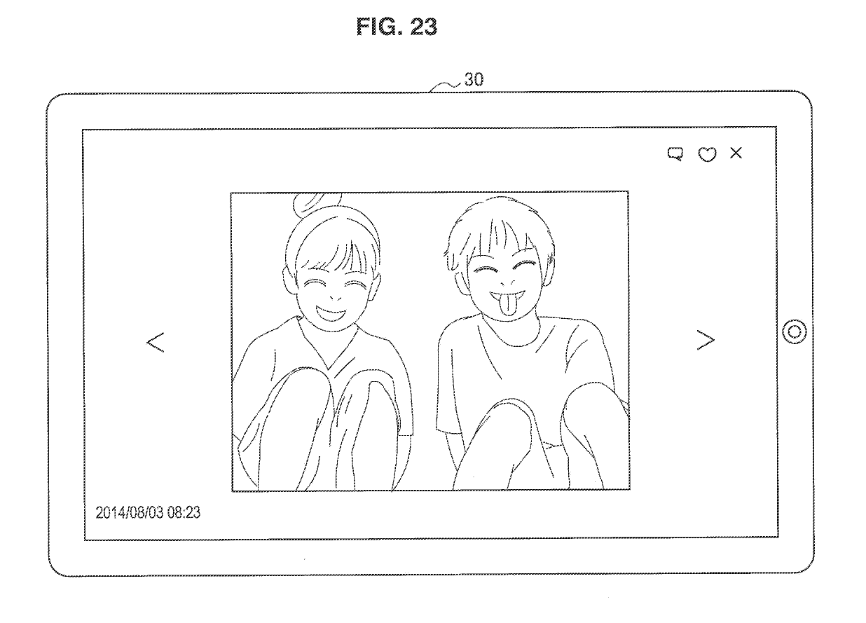

For example, it is assumed that the receiver selects “2014 August”. In this case, as illustrated in FIG. 22, a photo album of August, 2014 (corresponding to the display screen illustrated in FIG. 19) is displayed. The receiver can browse and confirm content of the photo album while scrolling display in the vertical direction. Further, when the receiver selects one of photographs within the photo album, as illustrated in FIG. 23, the selected photograph is enlarged and displayed at full size (corresponding to the display screen illustrated in FIG. 20).

The UI provided to the receiver upon browsing of the photo album has been described above.

### (4-2-3. Upon Feedback (Sender Side))

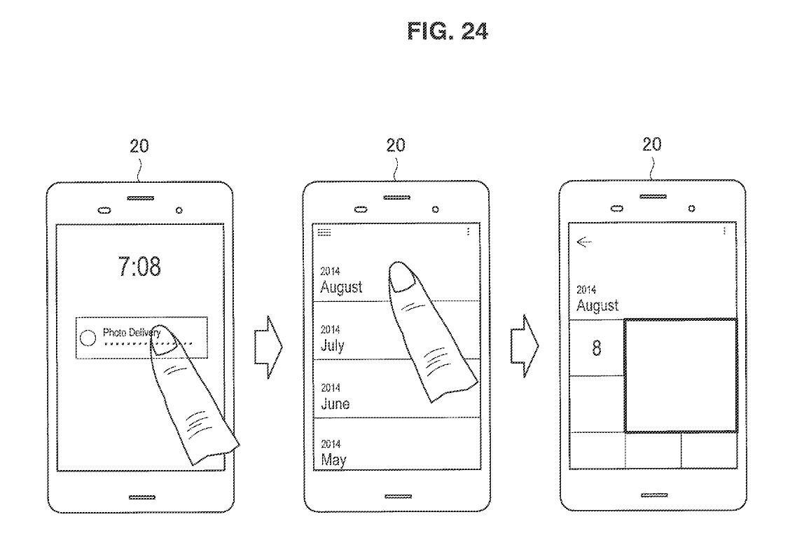

As described above, in the system 1, a function of detecting the receiver's favorite photograph manually or automatically when the receiver browses the photo album and feeding back information as to the favorite photograph to the sender may be provided. FIG. 24 is a diagram illustrating a display screen relating to the UI provided to the sender when information as to the favorite photograph is fed back. Note that, while FIG. 24 illustrates display in the case where the information processing terminal 20 is a smartphone as an example, also in the case where the information processing terminal 20 is a PC, a similar screen may be displayed while only an operation method by the sender is different.

When the receiver browses the photo album, for example, as illustrated in FIG. 24, the information processing terminal 20 which is the sender side is notified of information indicating that the receiver browses the photo album ((a)). When an icon indicating the notification is selected, a browser for browsing the photo album is activated, and a screen in which a list of titles of photo albums generated for each month is displayed is displayed ((b)). The sender can select a photo album the sender desires to browse from the list while scrolling the list.

For example, when the sender selects “2014 August” which is the latest photo album, a photo album of August, 2014 is displayed ((c)). The sender can browse the photo album while scrolling display. Here, in the photo album, the receiver's favorite photo is highlighted. In the illustrated example, the favorite photograph is displayed while the favorite photograph is made larger than other photographs and a frame is added (enclosed by a solid line). The sender who browses the photo album can confirm the receiver's favorite photograph by referring to the highlighted display. In this manner, in the case where some kinds of FB is provided from the receiver who browses the photo album, the sender can confirm what kind of reaction is made to which photograph as if the sender experienced action of the receiver vicariously by browsing the photo album in a similar manner.

The UI provided to the sender upon feedback of the favorite photograph has been described above.

### 5. Modified Examples

Some modified examples in the above-described embodiment will be described.

### (5-1. Other Display Examples in Display Pattern B)

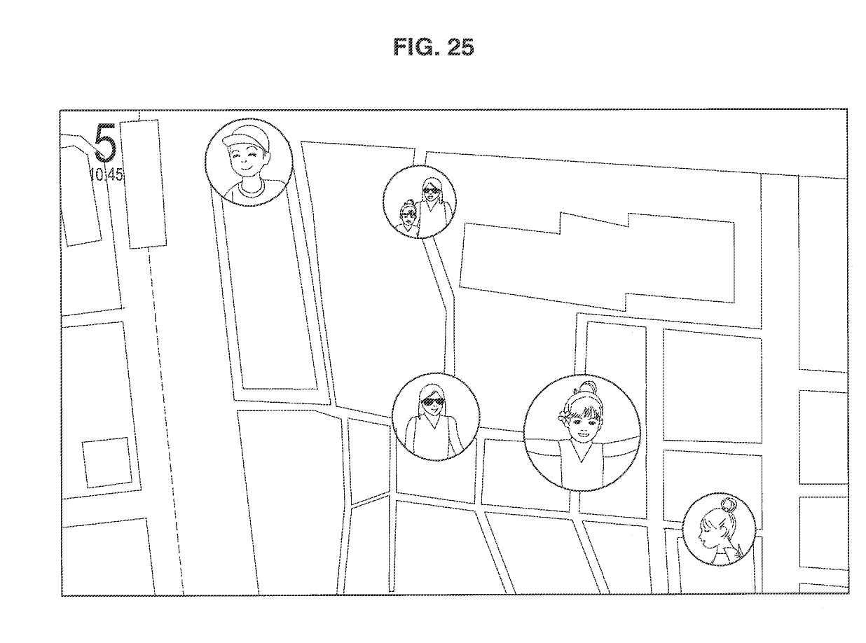

Other display examples in the display pattern B will be described with reference to FIG. 25 to FIG. 30. FIG. 25 to FIG. 30 are diagrams illustrating other display examples in the display pattern B. In the above-described display example illustrated in FIG. 4, in the display pattern B, relation between photographing locations on a map and images photographed at the photographing locations is expressed by the photographing locations and the images being connected with lines. However, the display pattern B is not limited to this example.

For example, as illustrated in FIG. 25, images may be directly displayed at positions corresponding to the photographing locations on the map. According to this display example, compared to a case where relation is expressed through connection with lines as illustrated in FIG. 4, the user who browses the display screen can recognize association between the photographing locations and the images more intuitively.

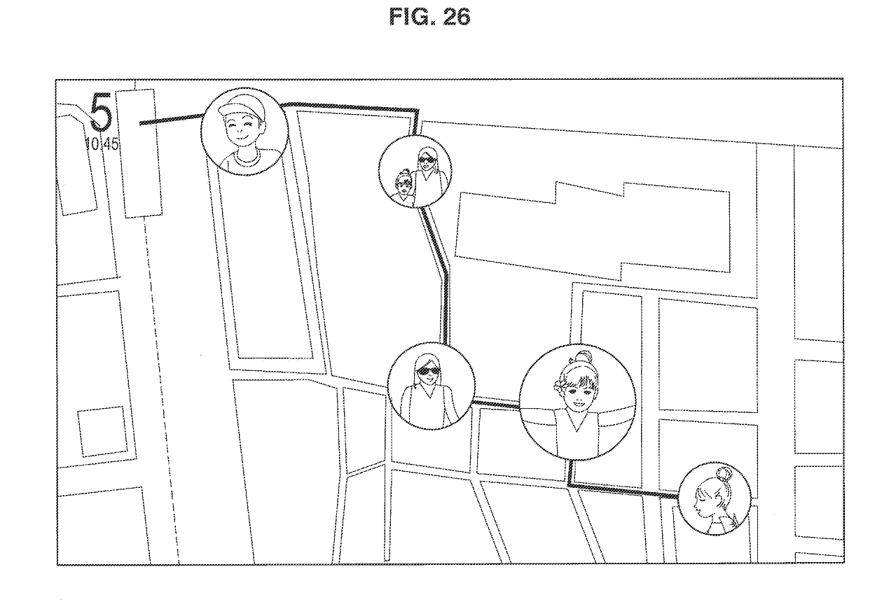

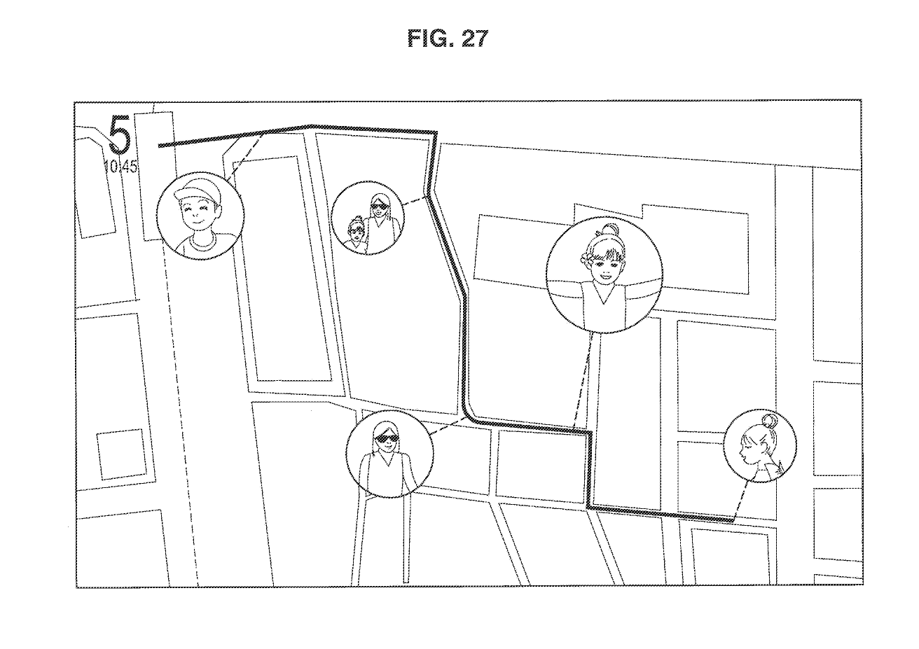

Further, in this case, as illustrated in FIG. 26, a migration path of the photographer may be also displayed on the map along with the images. The migration path may be created by, for example, the information processing apparatuses 10 and 10a linking position information of image data in the order of photographing time or may be created on the basis of history of the position information by the information processing apparatuses 10 and 10a acquiring history of position information of a wearable device possessed by the user or a device itself which takes photographs. Further, as illustrated in FIG. 27, also in the case where relation between the photographing locations and the images is expressed by the both being connected with lines, a migration path of the photographer may be also displayed on the map along with the images. By also displaying the migration path along with the images, the user who browses the display pattern can confirm trajectory of movement of the photographer along with each image.

Note that, in the case where a group of images is displayed on a map which is enlarged as illustrated in FIG. 25 to FIG. 27, the background map may be moved so that the latest image (that is, an image photographed latest among images being displayed) is located at substantially the center within the display region. By this means, the user who browses the display pattern can recognize trajectory of movement of the photographer more intuitively. Further, in this event, as illustrated in FIG. 26 and FIG. 27, if the migration path is also displayed along with the images, the user who browses the display pattern can recognize change of the map in accordance with movement more easily.

Here, while, in the display pattern B, as described with reference to FIG. 7A to FIG. 7I, display is sequentially switched by scrolling operation in the vertical direction, because display does not simply move in the vertical direction unlike with other display patterns, a direction of the scrolling operation does not always coordinate with a direction of change of the display. Therefore, there is a possibility that some users may feel uncomfortable in operation. To address this, in the display pattern B, the display may be controlled so that images move in coordination with the scrolling operation. By this means, the user can also visually obtain a sense that the user performs scrolling operation, so that it is possible to improve operability of the user.

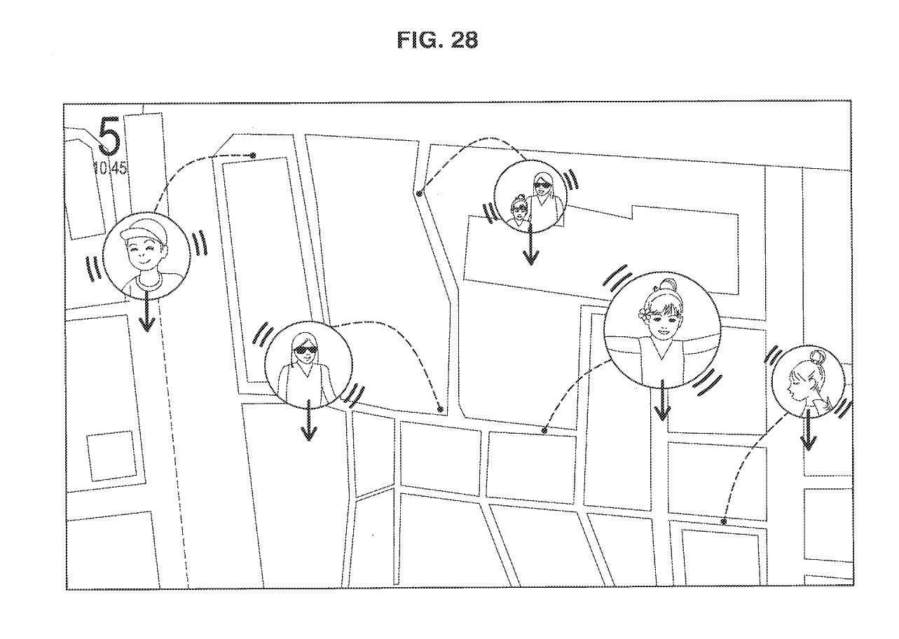

FIG. 28 illustrates a display example in such a case where images move in coordination with scrolling operation. FIG. 28 illustrates as an example, an aspect where images slightly move so that the images swing in a downward direction so as to resist a direction of scrolling operation as if inertial force were applied in accordance with scrolling operation for sending the whole display in an upward direction. However, the method for displaying movement of the images is not limited to this example, and movement of the images may be displayed using any method if the method can provide a feeling to the user as if the user performed scrolling operation.

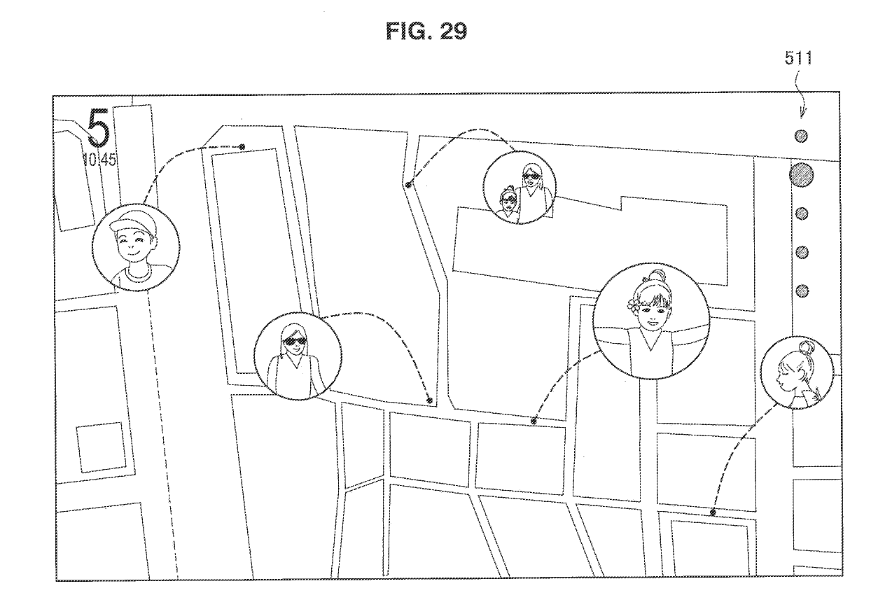

Further, as other methods for improving operability of the user upon scrolling operation, as illustrated in FIG. 29, an indicator 511 indicating which part in the whole display pattern the user is currently browsing may be displayed within the display pattern. In the illustrated example, the indicator 511 is configured so that a plurality of circles are arranged and displayed in the vertical direction and a circle corresponding to the part which the user is currently browsing is made larger than other circles and displayed.

Note that the number of circles of the indicator 511 may correspond to the number of images arranged on the display pattern. In the case where, for example, an image is displayed while the image is gradually enlarged as illustrated in FIG. 7A to FIG. 7I, a circle corresponding to each image may be enlarged in coordination with enlargement of each image. In this case, circles corresponding to respective images can be arranged from the top to the bottom in the order that the image is enlarged and displayed, that is, in chronological order. That is, as the images are sequentially gradually enlarged and displayed, a position of a circle which is enlarged and displayed at the indicator 511 moves from the top to the bottom.

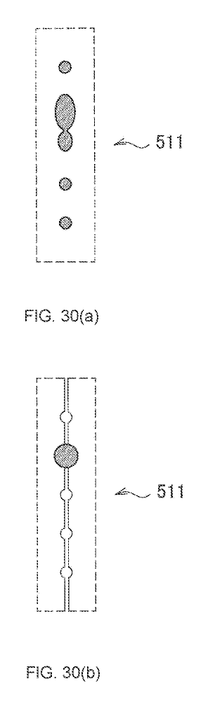

Note that the indicator 511 is not limited to this example, and may have other shapes. FIG. 30 illustrates another display example of the indicator 511. As illustrated in FIG. 30, the indicator 511 may be configured so that, for example, a plurality of circles are arranged and displayed in the vertical direction, and other circles are displayed while moving in the vertical direction in the display in coordination with scrolling operation as if droplets moved ((a)). Alternatively, for example, the indicator 511 may be configured so that a plurality of circles are arranged in the vertical direction, these circles are displayed by being connected with straight lines, and a circle corresponding to a part which the user is currently browsing is displayed while the circle is made larger than other circles ((b)). Further, any display typically used as an indicator upon scrolling display may be applied to the indicator 511.

Here, as described above, because, in the display pattern B, a direction of scrolling operation does not always coordinate with a direction of change, there can occur a problem that it is difficult for the user to know an end point (a lowermost end of the display pattern) of the scrolling display. By providing the above-described indicator 511, such a problem that it is difficult to know the end point can be resolved. Note that a UI which notifies the user of the end point of the scrolling display may be provided in addition to the indicator 511 or in place of the indicator 511. As the UI, various kinds of UIs typically used for notifying the user of the end point of the scrolling display may be used, for example, display is performed while the lower end is illuminated in the case where the scrolling display reaches the end point, or the whole display is moved so as to bounce back (so-called bounce back) in the case where the scrolling display reaches the end point, or the like.

### (5-2. Criterion for Image Extraction Processing and Display Pattern Determination Processing)

A criterion used by the image data extracting unit 112 to extract image data, and a criterion used by the display pattern determining unit 113 to determine the display pattern are not limited to those described in the above-described embodiment. The image data extracting unit 112 and the display pattern determining unit 113 can determine an image to be extracted and a display pattern while comprehensively taking into account action history of the user, history of image data acquired in the past, a result of FB by the receiver, or the like.

For example, the information processing apparatuses 10 and 10a can analyze where the user usually acquires most images, frequency the user visits a location where an image is photographed, whether a similar image has been photographed in the past at the same location, the number of images photographed in one event, a travel distance of the user from the home, a travel distance of the user in one event, density of photographing locations of images in one event, an interval of photographing time of images in one event, or the like, on the basis of action history of the user and/or history of image data.

For example, the display pattern determining unit 113 can estimate that the user visits a location quite far from an activity range of daily life (that is, the user travels) by taking into account the analysis result as well as scattering of position information, and can determine the display pattern B as the display pattern.

Further, for example, the display pattern determining unit 113 employs the display pattern B for a group of images in the case where it is estimated on the basis of the above-described analysis result that the target group of images is a group of images photographed in an event aimed at “movement”, such as a group of images photographed when the user goes cycling. In such an event aimed at “movement”, because there can be a desire to see change of scenery during movement, the display pattern B in which the map and images are displayed in association with each other can be preferably employed. Note that, in this event, for example, even during cycling, in the case where a number of images are photographed at a predetermined spot (in the case where density of photographing locations of images is large at the predetermined spot) such as in the case where the user has dropped into a tourist spot and has photographed images, various kinds of ways may be used on layout to improve visibility of the images, for example, association between the photographing locations and the images is indicated by linking lines extending from the photographing locations with the images as illustrated in FIG. 4, the map is enlarged and displayed, or the like.

Further, for example, the display pattern determining unit 113 employs the display pattern D for a group of images in the case where it is estimated on the basis of the above-described analysis result that the target group of images is a group of images photographed in an event aimed at “activity” at a location after movement, such as a group of images photographed when the user participates in a workshop. In such an event aimed at “activity”, because there can be a desire to see images indicating how the “activity” goes and a result of the “activity” (images indicating how the work goes and the created work in the above-described example) instead of an image indicating what kind of location, the display pattern D in which relatively large images are displayed and captions of these images can be displayed can be preferably employed.

Further, for example, the display pattern determining unit 113 determines combination of the display pattern B and the display pattern D for a group of images in the case where, on the basis of the above-described analysis result, the target group of images is a group of images equally photographed both during movement to a destination and at the destination (for example, in the case where the user goes to a house of grandparents from the home, or the like). For example, the display pattern determining unit 113 employs the display pattern B for images photographed while the user moves from the home to a destination to associate history of movement with the images. Then, the display pattern determining unit 113 employs the display pattern C for images photographed at the destination to indicate a circumstance of the destination in more detail.

Further, the image data extracting unit 112 can prevent the image data from being made a target of extraction on the basis of the above-described analysis result in the case where similar images have been photographed at the same location in the past.

Alternatively, the image data extracting unit 112 and the display pattern determining unit 113 can increase a ratio of images to be extracted which are similar to the favorite image or increase sizes of images similar to an image selected as the favorite image compared to sizes of other images on the basis of the result of FB by the receiver.

### (5-3. Scrolling Operation)

In the present embodiment, a method for performing scrolling operation when the user browses the display screen is not uniquely limited, and scrolling operation may be performed using various kinds of methods. For example, in the case where the information processing terminals 20 and 30 perform operation input using a mouse, scrolling operation may be performed through movement of an indicator bar using a pointer, rotation of a wheel of a mouse, or the like. Further, for example, in the case where the information processing terminals 20 and 30 perform operation input using a touch panel, scrolling operation may be performed through drag operation in the vertical direction, or the like. Further, for example, in the case where the information processing terminals 20 and 30 have an input device which can designate a direction, such as an arrow key, scrolling operation may be performed through the input device.

Alternatively, in the case where the information processing terminals 20 and 30 include a function of detecting the line of sight of the user, scrolling operation may be performed by the user moving his/her line of sight in the vertical direction. Further, in the case where the information processing terminals 20 and 30 include a function of detecting motion of the user, scrolling operation may be performed by the user performing gesture. Further, in the case where the information processing terminals 20 and 30 include a function of detecting the own inclination using a gyro sensor, or the like, scrolling operation may be performed by the user performing operation of inclining the information processing terminals 20 and 30.

Further, scrolling display of the display screen does not always have to respond to scrolling operation by the user, and the display screen may be displayed while automatically scrolled at predetermined speed. In this case, it is also possible to allow the user to stop scrolling display at an arbitrary timing through appropriate operation such as, for example, click using a mouse and tap operation to the touch panel.

### (5-4. Display Apparatus)

In the present embodiment, a display method of information at the information processing terminals 20 and 30, particularly, a display method of a display screen (photo album) is not uniquely limited, and various kinds of display methods may be used. For example, the information processing terminals 20 and 30 may have a display apparatus, and may display various kinds of information such as a photo album on a display screen of the display apparatus. As the display apparatus, various kinds of publicly known display apparatuses such as, for example, a cathode ray tube (CRT) display apparatus, a liquid crystal display apparatus, a plasma display apparatus and an electroluminescence (EL) display apparatus may be used.

Alternatively, the information processing terminals 20 and 30 may have a projector apparatus and display various kinds of information such as a photo album on a screen, a wall surface, or the like, using the projector apparatus.

Alternatively, the information processing terminals 20 and 30 may be combined with an interactive system of a table top and may display various kinds of information such as a photo album on a table top. The interactive system of the table top is, for example, a system which allows the user to directly execute various kinds of operation on an virtual object displayed on an upper surface by projecting an image on the upper surface of a table from above and detecting motion, or the like, of the hand of the user on the upper surface using a sensor. For example, scrolling operation of the photo album can be performed through direct gesture with respect to the photo album displayed on the table top (such as, for example, action of moving the hand along the vertical direction of the photo album over the displayed photo album).

Alternatively, the information processing terminals 20 and 30 may overlay and display various kinds of information such as a photo album in real space using an augmented reality (AR) technology. For example, the information processing terminals 20 and 30 have a camera which can photograph surrounding space and a display apparatus, display the surrounding space photographed using the camera on a display screen of the display apparatus and overlay and display a photo album, or the like on the display screen. Alternatively, the information processing terminals 20 and 30 may be a spectacle type wearable device or a transmission type HMD, and, by displaying a photo album, or the like, on a display surface, may overlay and display the photo album, or the like, on surrounding space directly observed by the user via the display surface.

Further, in the case where a photo album, or the like, is overlaid and displayed on space using the AR technology, motion of the hand, or the like, of the user in the space may be detected using a sensor, and the user may be allowed to directly execute various kinds of operation on, for example, a virtual object which is overlaid and displayed. For example, scrolling operation of the photo album can be performed through direct gesture with respect to the photo album displayed on space (such as, for example, by moving the hand over the displayed photo album along the vertical direction of the photo album).

### 6. Hardware Configuration

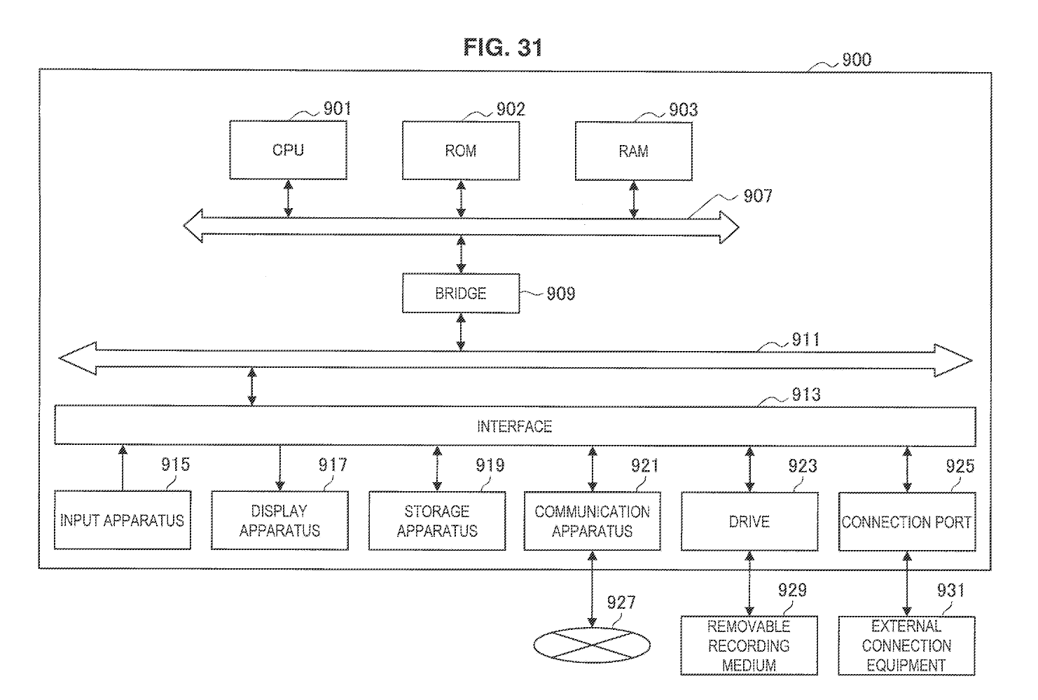

A hardware configuration of the information processing apparatus according to the present embodiment will be described with reference to FIG. 31. FIG. 31 is a block diagram illustrating an example of the hardware configuration of the information processing apparatus according to the present embodiment. Note that an information processing apparatus 900 illustrated in FIG. 31 can realize the information processing apparatus 10 illustrated in FIG. 1, the information processing apparatus 10a illustrated in FIG. 11 and the information processing terminals 20 and 30 illustrated in FIG. 11.

The information processing apparatus 900 includes a CPU 901, a read only memory (ROM) 903 and a random access memory (RAM) 905. Further, the information processing apparatus 900 may include a host bus 907, a bridge 909, an external bus 911, an interface 913, an input apparatus 915, an output apparatus 917, a storage apparatus 919, a communication apparatus 921, a drive 923 and a connection port 925. The information processing apparatus 900 may have a processing circuit such as a DSP and an ASIC in place of or in addition to the CPU 901.

The CPU 901, which functions as an arithmetic processing apparatus and a control apparatus, controls the whole operation or part of the operation within the information processing apparatus 900 in accordance with various kinds of programs recorded in the storage apparatus 919 or a removable recording medium 929. The ROM 903 stores a program, an operation parameter, or the like, to be used by the CPU 901. The RAM 905 temporarily stores a program to be used for execution of the CPU 901, a parameter upon execution, or the like. The CPU 901, the ROM 903 and the RAM 905 are connected to each other using the host bus 907 which is configured with internal buses such as a CPU bus. In the present embodiment, for example, by the CPU 901 operating in accordance with a predetermined program, each function of the above-described information processing apparatuses 10 and 10a and the information processing terminals 20 and 30 can be implemented. The CPU 901 can correspond to the control units 110 and 110a illustrated in FIG. 1 and FIG. 11.

The host bus 907 is connected to the external bus 911 such as a peripheral component interconnect/interface (PCI) bus via the bridge 909.

The input apparatus 915 is configured with, for example, apparatuses operated by the user, such as a mouse, a keyboard, a touch panel, a button, a switch and a lever. Further, the input apparatus 915 may be, for example, a remote control apparatus (so-called a remote control) utilizing infrared light or other radio waves or may be external connection equipment 931 such as a smartphone and a PDA which supports operation of the information processing apparatus 900. Still further, the input apparatus 915 is configured with, for example, an input control circuit which generates an input signal on the basis of information input by the user using the above-described operation means and outputs the input signal to the CPU 901. The user of the information processing apparatus 900 can input various kinds of data to the information processing apparatus 900 or instruct the information processing apparatus 900 to perform processing operation by manipulating the input device 915. In the present embodiment, for example, scrolling operation, or the like, for browsing a display screen (photo album) can be performed by the user via the input apparatus 915.

The output apparatus 917 is configured with an apparatus which can visually or aurally notify the user of the acquired information. Such an apparatus can include a display apparatus such as a CRT display apparatus, a liquid crystal display apparatus, a plasma display apparatus, an EL display apparatus and a lamp, an audio output apparatus such as a speaker and a headphone, a printer apparatus, or the like. The output apparatus 917, for example, outputs a result obtained through various kinds of processing performed by the information processing apparatus 900. Specifically, the display apparatus visually displays a result obtained through various kinds of processing performed by the information processing apparatus 900 in various forms such as text, images, tables and graphs. In the present embodiment, for example, a display screen (photo album) can be displayed at the display apparatus. Meanwhile, the audio output apparatus converts audio signals formed with reproduced audio data, acoustic data, or the like, into analog signals and aurally outputs the analog signals.

The storage apparatus 919 is an apparatus for data storage configured as an example of the storage unit of the information processing apparatus 900. The storage apparatus 919 is configured with, for example, a magnetic storage unit device such as an HDD, a semiconductor storage device, an optical storage device, a magnetooptical storage device, or the like. The storage apparatus 919 stores a program to be executed by the CPU 901, various kinds of data and various kinds of externally acquired data, or the like. In the present embodiment, the storage apparatus 919 can correspond to the storage unit 120 illustrated in FIG. 1 and FIG. 11.

The communication apparatus 921 is, for example, a communication interface configured with a communication device, or the like, for connecting to a network 927. The communication apparatus 921 is, for example, a communication card, or the like, for a wired or wireless local area network (LAN), a Bluetooth (registered trademark) or a wireless USB (WUSB). Further, the communication apparatus 921 may be a router for optical communication, a router for asymmetric digital subscriber line (ADSL), a modem for various kinds of communication, or the like. The communication apparatus 921 can, for example, transmit/receive signals, or the like, to/from the Internet or other communication equipment on the basis of predetermined protocol such as, for example, TCP/IP. Further, the network 927 connected to the communication apparatus 921 is configured with a network, or the like, connected in a wired or wireless manner, and may be, for example, the Internet, a LAN at home, infrared communication, radio wave communication, satellite communication, or the like. In the present embodiment, for example, the information processing apparatuses 10 and 10a and the information processing terminals 20 and 30 can be connected so as to be able to communicate with each other via the network 927 by the communication apparatus 921.

The drive 923, which is a reader/writer for recording medium, is incorporated into or externally attached to the information processing apparatus 900. The drive 923 reads out information recorded in the mounted removable recording medium 929 such as a magnetic disk, an optical disk, a magnetooptical disk and a semiconductor memory and outputs the information to the RAM 905. Further, the drive 923 can write information in the mounted removable recording medium 929 such as a magnetic disk, an optical disk, a magnetooptical disk and a semiconductor memory. The removable recording medium 929 is, for example, a DVD medium, an HD-DVD medium, a Blue-ray (registered trademark) medium, or the like. Further, the removable recording medium 929 may be a compact flash (registered trademark) (CF), a flash memory, a secure digital memory card (SD memory card), or the like. Further, the removable recording medium 929 may be, for example, an integrated circuit card (IC card), electronic equipment, or the like, in which a non-contact IC chip is mounted. In the present embodiment, various kinds of information to be processed by the CPU 901 may be read out from the removable recording medium 929 or written in the removable recording medium 929 by the drive 923.

The connection port 925 is a port for directly connecting equipment to the information processing apparatus 900. As an example of the connection port 925, there are a universal serial bus (USB) port, an IEEE1394 port, a small computer system interface (SCSI) port, or the like. As other examples of the connection port 925, there are an RS-232C port, an optical audio terminal, a high-definition multimedia interface (HDMI) (registered trademark) port, or the like. By connecting the external connection equipment 931 to the connection port 925, the information processing apparatus 900 directly acquires various kinds of data from the external connection equipment 931 or provide various kinds of data to the external connection equipment 931. In the present embodiment, various kinds of information to be processed by the CPU 901 may be acquired from the external connection equipment 931 or output to the external connection equipment 931 via the connection port 925.

Note that, while illustration will be omitted, a camera (imaging apparatus) and/or a sensor may be further provided at the information processing apparatus 900. In the information processing apparatus 900, a photo album can be generated on the basis of photographs taken by the camera. Further, the sensor may be various kinds of sensors such as, for example, an acceleration sensor, a gyro sensor, a geomagnetic sensor, an optical sensor, a sound sensor, a distance measurement sensor, a force sensor and a global positioning system (GPS) sensor. In the information processing apparatus 900, action history of the user may be acquired or scrolling operation may be performed on the basis of detection values by these sensors.

Hereinbefore, an example of a hardware configuration of the information processing apparatus 900 according to this embodiment is shown. The respective components may be configured using universal members, or may be configured by hardware specific to the functions of the respective components. Accordingly, according to a technical level at the time when the embodiments are executed, it is possible to appropriately change hardware configurations to be used.

In addition, a computer program for realizing each of the functions of the information processing apparatus 900 according to the present embodiment may be created, and may be mounted in a PC or the like. Furthermore, a computer-readable recording medium on which such a computer program is stored may be provided. The recording medium is a magnetic disc, an optical disc, a magneto-optical disc, a flash memory, or the like, for example. The computer program may be delivered through a network, for example, without using the recording medium.

### 7. Supplement

The preferred embodiment of the present disclosure has been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Further, the effects described in this specification are merely illustrative or exemplified effects, and are not limitative. That is, with or in the place of the above effects, the technology according to the present disclosure may achieve other effects that are clear to those skilled in the art from the description of this specification.

For example, while, in the above-described embodiment, the map displayed in the display pattern B is a map relating to a location the user has visited, such as, for example, a map of a travel destination, the present technology is not limited to this example. For example, a plurality of images (photographs) may be photographed using an endoscope, and the map may be a map of a human body indicating photographing locations of photographs taken by the endoscope. In this case, because locations within a body cavity of a patient and photographs taken at the locations are displayed in association with each other, a doctor or the patient him/herself can intuitively recognize relationship between the locations and the photographs when referring to a detection result by the endoscope, so that it becomes easier to confirm the detection result. Note that the endoscope may be a so-called capsule endoscope.

Further, the above-described system 1 may be used for monitoring a condition (condition of health) of the receiver. For example, a function of notifying the sender that the receiver browses the photo album when the receiver browses the delivered photo album may be mounted on the system 1. For example, in the case where the sender is a son and his wife, and the receiver is their parents, in the case where the above-described notification does not arrive at the sender although the photo album is delivered, there is a possibility that the receiver does not confirm the photo album, and something abnormal is likely to occur at the receiver. In this manner, the system 1 may function as a so-called “watching system” for watching over elderly people who live separately.

Additionally, the present technology may also be configured as below.

(1)

An information processing apparatus including:

a display pattern determining unit configured to determine a display pattern of a plurality of images,

in which the display pattern determining unit determines, on the basis of scattering of a plurality of pieces of position information including position information associated with each of the plurality of images, a display pattern in which the plurality of images are arranged along with a map including a location corresponding to the position information.

(2)

The information processing apparatus according to (1),

in which the display pattern determining unit determines a display pattern in which the plurality of images are arranged along with a map including a location corresponding to the position information on the basis of scattering of the plurality of pieces of position information.

(3)

The information processing apparatus according to (2),

in which the display pattern determining unit determines a display pattern in which the plurality of images are arranged along with a map in accordance with judgment that variation of scattering of the position information is larger than a predetermined criterion.

(4)

The information processing apparatus according to (3),

in which the position information respectively associated with the plurality of images is position information indicating locations where the plurality of images are acquired, and

the display pattern determining unit determines the predetermined criterion on the basis of action history of a user who creates the plurality of images.

(5)

The information processing apparatus according to (4),

in which the display pattern determining unit determines the predetermined criterion so that a display pattern in which the plurality of images are arranged along with the map is determined for the plurality of images acquired at a location which the user less frequently visits, in accordance with frequency of the user visiting the location where the plurality of images are created within a predetermined period, the frequency being obtained on the basis of the action history.

(6)

The information processing apparatus according to (5),

in which the predetermined period for obtaining frequency of the user visiting the location where the plurality of images are created is a predetermined period going back from a current time point and is updated as needed.

(7)

The information processing apparatus according to (4),

in which the display pattern determining unit determines a value corresponding to an activity range in daily life of the user estimated on the basis of the action history as the predetermined criterion.

(8)

The information processing apparatus according to any one of (1) to (7),

in which, in the display pattern in which the plurality of images are arranged along with the map, the plurality of images are arranged in association with locations corresponding to the respective pieces of position information of the plurality of images on the map.

(9)

The information processing apparatus according to (8),

in which the plurality of images are respectively arranged on locations corresponding to the position information on the map.

(10)

The information processing apparatus according to (8),

in which the plurality of images are displayed by being respectively connected with lines to locations corresponding to the position information on the map.

(11)

The information processing apparatus according to any one of (1) to (10),

in which, when display relating to the display pattern in which the plurality of images are arranged along with the map is scrolled, the plurality of images are sequentially displayed in chronological order in accordance with scrolling on the basis of time information associated with each of the plurality of images.

(12)

The information processing apparatus according to (11),

in which, when the plurality of images are sequentially displayed in accordance with scrolling, display of the map changes so that a location corresponding to the position information of the image displayed most recently is located at substantially the center of a display region browsed by the user.

(13)

The information processing apparatus according to (11) or (12),

in which an indicator indicating a degree of progress of the scrolling is displayed together.

(14)

The information processing apparatus according to any one of (1) to (13),

in which the position information respectively associated with the plurality of images is position information indicating locations where the plurality of images are created, and

a migration path of the user when the plurality of images are created is displayed on the map.

(15)

The information processing apparatus according to any one of (1) to (14),

in which the plurality of images are photographs, position information respectively associated with the plurality of images is position information indicating photographing locations of the photographs, and time information respectively associated with the plurality of images is time information indicating photographing time of the photographs.

(16)

The information processing apparatus according to any one of (2) to (15),

in which the plurality of images are classified into categories in accordance with a predetermined criterion, and

the display pattern determining unit determines the display pattern for each of the categories.

(17)

The information processing apparatus according to (16), further including:

a display screen generating unit configured to generate a display screen in which the plurality of images are arranged for each of the categories in chronological order by combining the display patterns for each of the categories determined by the display pattern determining unit.

(18)

The information processing apparatus according to (16) or (17),

in which classification into the categories is performed through event clustering.

(19)

An information processing method including:

determining a display pattern of a plurality of images by a processor,

in which, on the basis of scattering of a plurality of pieces of position information including position information associated with each of the plurality of images, a display pattern in which the plurality of images are arranged along with a map including a location corresponding to the position information is determined.

(20)

A program causing a computer to implement:

a function of determining a display pattern of a plurality of images,

in which, on the basis of scattering of a plurality of pieces of position information including position information associated with each of the plurality of images, a display pattern in which the plurality of images are arranged along with a map including a location corresponding to the position information is determined.

### REFERENCE SIGNS LIST

1 system
10, 10a information processing apparatus
20, 30 information processing terminal
110, 110a control unit
111 image data acquiring unit
112 image data extracting unit
113 display pattern determining unit
114 display screen generating unit
115 FB acquiring unit
120 storage unit

1. An information processing apparatus comprising:
a display pattern determining unit configured to determine a display pattern of a plurality of images,
wherein the display pattern determining unit determines, on the basis of scattering of a plurality of pieces of position information including position information associated with each of the plurality of images, a display pattern in which the plurality of images are arranged along with a map including a location corresponding to the position information.

2. The information processing apparatus according to claim 1,
wherein the display pattern determining unit determines a display pattern in which the plurality of images are arranged along with a map including a location corresponding to the position information on the basis of scattering of the plurality of pieces of position information.

3. The information processing apparatus according to claim 2,
wherein the display pattern determining unit determines a display pattern in which the plurality of images are arranged along with a map in accordance with judgment that variation of scattering of the position information is larger than a predetermined criterion.

4. The information processing apparatus according to claim 3,
wherein the position information respectively associated with the plurality of images is position information indicating locations where the plurality of images are acquired, and
the display pattern determining unit determines the predetermined criterion on the basis of action history of a user who creates the plurality of images.

5. The information processing apparatus according to claim 4,
wherein the display pattern determining unit determines the predetermined criterion so that a display pattern in which the plurality of images are arranged along with the map is determined for the plurality of images acquired at a location which the user less frequently visits, in accordance with frequency of the user visiting the location where the plurality of images are created within a predetermined period, the frequency being obtained on the basis of the action history.

6. The information processing apparatus according to claim 5,
wherein the predetermined period for obtaining frequency of the user visiting the location where the plurality of images are created is a predetermined period going back from a current time point and is updated as needed.

7. The information processing apparatus according to claim 4,
wherein the display pattern determining unit determines a value corresponding to an activity range in daily life of the user estimated on the basis of the action history as the predetermined criterion.

8. The information processing apparatus according to claim 1,
wherein, in the display pattern in which the plurality of images are arranged along with the map, the plurality of images are arranged in association with locations corresponding to the respective pieces of position information of the plurality of images on the map.

9. The information processing apparatus according to claim 8,
wherein the plurality of images are respectively arranged on locations corresponding to the position information on the map.

10. The information processing apparatus according to claim 8,
wherein the plurality of images are displayed by being respectively connected with lines to locations corresponding to the position information on the map.

11. The information processing apparatus according to claim 1,
wherein, when display relating to the display pattern in which the plurality of images are arranged along with the map is scrolled, the plurality of images are sequentially displayed in chronological order in accordance with scrolling on the basis of time information associated with each of the plurality of images.

12. The information processing apparatus according to claim 11,
wherein, when the plurality of images are sequentially displayed in accordance with scrolling, display of the map changes so that a location corresponding to the position information of the image displayed most recently is located at substantially the center of a display region browsed by the user.

13. The information processing apparatus according to claim 11,
wherein an indicator indicating a degree of progress of the scrolling is displayed together.

14. The information processing apparatus according to claim 1,
wherein the position information respectively associated with the plurality of images is position information indicating locations where the plurality of images are created, and
a migration path of the user when the plurality of images are created is displayed on the map.

15. The information processing apparatus according to claim 1,
wherein the plurality of images are photographs, position information respectively associated with the plurality of images is position information indicating photographing locations of the photographs, and time information respectively associated with the plurality of images is time information indicating photographing time of the photographs.

16. The information processing apparatus according to claim 2,
wherein the plurality of images are classified into categories in accordance with a predetermined criterion, and
the display pattern determining unit determines the display pattern for each of the categories.

17. The information processing apparatus according to claim 16, further comprising:
a display screen generating unit configured to generate a display screen in which the plurality of images are arranged for each of the categories in chronological order by combining the display patterns for each of the categories determined by the display pattern determining unit.

18. The information processing apparatus according to claim 16,
wherein classification into the categories is performed through event clustering.

19. An information processing method comprising:
determining a display pattern of a plurality of images by a processor,
wherein, on the basis of scattering of a plurality of pieces of position information including position information associated with each of the plurality of images, a display pattern in which the plurality of images are arranged along with a map including a location corresponding to the position information is determined.

20. A program causing a computer to implement:
a function of determining a display pattern of a plurality of images,
wherein, on the basis of scattering of a plurality of pieces of position information including position information associated with each of the plurality of images, a display pattern in which the plurality of images are arranged along with a map including a location corresponding to the position information is determined.
